(19) United States
(12) Patent Application Publication
(10) Pub. No.: US 2010/0238414 A1
(43) Pub. Date: Sep. 23, 2010

(54) Visual display device

(76) Inventor: Takayoshi Togino, Koganei-shi (JP)

Correspondence Address: Richard M. Rosati, Esq.;Kenyon & Kenyon LLP, One Broadway, New York, NY, 10004, US

(21) Appl. No.: 12/661,569

(22) Filed: Mar. 19, 2010

(30) Foreign Application Priority Data
Mar. 23, 2009 (JP) 2009-069757
Mar. 23, 2009 (JP) 2009-069758
Jan. 20, 2010 (JP) 2010-009939

(51) Int. Cl. G02B 17/08; G02B 25/00; G03B 21/14

(52) U.S. Cl. 353/38; 359/362; 359/364

(57) ABSTRACT

A visual display device includes an image display element 3 and an ocular optical system 5 that allows a viewer to observe an image displayed on the image display element 3 as a virtual image in a remote location. The ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

### BACKGROUND OF THE INVENTION

1. Technical Field

The present invention relates to a visual display device capable of displaying a wide observation viewing angle.

2. Background Art

There is known an optical system that observes a virtual image as disclosed in JP-A-10-206790.

### SUMMARY OF THE INVENTION

Preferably, a visual display device includes: an image display element; and an ocular optical system that allows a viewer to observe an image displayed on the image display element as a virtual image in a remote location, the ocular optical system includes: at least one reflection optical element; at least one transmission optical element; and a visual axis including a central main light beam in the reverse raytrace of the ocular optical system which is directed from the center of an entrance pupil toward the reflection optical element through the transmission optical element, and the number of times of image formation is different between in a first cross-section including the visual axis and a second cross-section which is perpendicular to the first cross-section and includes the visual axis.

Preferably, the number of times of image formation is 0 in the first cross-section and 1 in the second cross-section.

Preferably, the reflection optical element and transmission optical element each have a stronger refractive index in the direction toward the second cross-section.

Preferably, the reflection optical element and transmission optical element are each rotationally symmetric with respect to one rotationally symmetrical axis.

Preferably, the second cross-section includes the rotationally symmetrical axis.

Preferably, the reflection optical element is eccentric with respect to the visual axis in the second cross-section.

Preferably, the visual axis and rotationally symmetrical axis are perpendicular to each other.

Preferably, the reflection optical element is a cylindrical linear Fresnel reflection element.

Preferably, one side and the other side of the reflection optical element with respect to the visual axis have different shapes in the second cross-section.

Preferably, the transmission optical element is a curved cylindrical linear Fresnel transmission element.

Preferably, one side and the other side of the transmission optical element with respect to the visual axis have different shapes in the second cross-section.

Preferably, the following conditional expression (1) is satisfied:

|Ry|<|Rx| (1)

where Rx is the radius of curvature of the reflection surface of the reflection optical element in the vicinity where the reflection optical element is intersected by the visual axis in the first cross-section, and Ry is the radius of curvature of the reflection surface of the reflection optical element in the vicinity where the reflection optical element is intersected by the visual axis in the second cross-section.

Preferably, the following conditional expression (2) is satisfied:

|F|<|Rx| (2)

where Fy is the focal length of the cross-section including the rotationally symmetrical axis of the transmission optical element, and Rx is the radius of curvature of the reflection surface of the reflection optical element in the vicinity where the reflection optical element is intersected by the visual axis in the first cross-section.

Preferably, the visual display device includes at least two transmission optical elements.

Preferably, the at least two transmission optical elements each have a rotationally symmetric surface with the same rotationally symmetrical axis as that of the reflection surface.

Preferably, the at least two transmission optical elements are disposed symmetric with respect to the second cross-section.

Preferably, one of the transmission optical elements has the same rotationally symmetrical axis as that of the reflection surface, and the other one thereof is disposed symmetric with respect to the second cross-section.

Preferably, the visual display device further includes: a projection optical system that projects an image displayed on the image display element; and a diffusion surface disposed in the vicinity of the image projected by the projection optical system, wherein a projection image projected by the projection optical system is concentrically disposed with respect to the rotationally symmetrical axis.

Preferably, the projection optical system is rotationally symmetric with respect to the rotationally symmetrical axis.

Preferably, the image display element has a curved surface rotationally symmetric with respect to the rotationally symmetrical axis.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is a conceptual view of a visual display device according to a first embodiment;

FIG. 2 is a plan view of FIG. 1;

FIG. 3 is a view showing a display example of an image display element;

FIG. 4 is a view showing another display example of the image display element;

FIG. 5 is a view showing a configuration in which the visual display device and a seat are combined;

FIG. 6 is a view showing a coordinate system of the visual display device of the first embodiment;

FIG. 7 is a view showing a definition of an extended rotation free-form surface;

FIG. 8 is a cross-sectional view of the visual display device of Example 1 taken along the rotationally symmetrical axis;

FIG. 9 is a plan view of FIG. 8;

FIG. 10 is a diagram showing lateral aberration of the entire optical system of Example 1;

FIG. 11 is a cross-sectional view of the visual display device of Example 2 taken along the rotationally symmetrical axis;

FIG. 12 is a plan view of FIG. 11;

FIG. 13 is a diagram showing lateral aberration of the entire optical system of Example 2;

FIG. 14 is a cross-sectional view of the visual display device of Example 3 taken along the rotationally symmetrical axis;

FIG. 15 is a plan view of FIG. 14;

FIG. 16 is a diagram showing lateral aberration of the entire optical system of Example 3;

FIG. 17 is a cross-sectional view of the visual display device of Example 4 taken along the rotationally symmetrical axis;

FIG. 18 is a plan view of FIG. 17;

FIG. 19 is a diagram showing lateral aberration of the entire optical system of Example 4;

FIG. 20 is a cross-sectional view of the visual display device of Example 5 taken along the rotationally symmetrical axis;

FIG. 21 is a plan view of FIG. 20;

FIG. 22 is a diagram showing lateral aberration of the entire optical system of Example 5;

FIG. 23 is a cross-sectional view of the visual display device of Example 6 taken along the rotationally symmetrical axis;

FIG. 24 is a plan view of FIG. 23;

FIG. 25 is a diagram showing lateral aberration of the entire optical system of Example 6;

FIG. 26 is a cross-sectional view of the visual display device of Example 7 taken along the rotationally symmetrical axis;

FIG. 27 is a plan view of FIG. 26;

FIG. 28 is a diagram showing lateral aberration of the entire optical system of Example 7;

FIG. 29 shows a conceptual view of a reference example of the visual display device of the first embodiment;

FIG. 30 is a plan view of FIG. 29;

FIG. 31 is a conceptual view of a visual display device according to a second embodiment;

FIG. 32 is a plan view of FIG. 31;

FIG. 33 is a view showing a configuration in which the visual display device of the second embodiment and a seat are combined;

FIG. 34 is a view showing a coordinate system of the visual display device of the second embodiment;

FIG. 35 is a cross-sectional view of the visual display device of Example 8 taken along the rotationally symmetrical axis;

FIG. 36 is a plan view of FIG. 35;

FIG. 37 is a diagram showing lateral aberration of the entire optical system of Example 8;

FIG. 38 is a cross-sectional view of the visual display device of Example 9 taken along the rotationally symmetrical axis;

FIG. 39 is a plan view of FIG. 38;

FIG. 40 is a diagram showing lateral aberration of the entire optical system of Example 9;

FIG. 41 is a cross-sectional view of the visual display device of Example 10 taken along the rotationally symmetrical axis;

FIG. 42 is a plan view of FIG. 41;

FIG. 43 is a diagram showing lateral aberration of the entire optical system of Example 10;

FIG. 44 is a cross-sectional view of the visual display device of Example 11 taken along the rotationally symmetrical axis;

FIG. 45 is a plan view of FIG. 44;

FIG. 46 is a diagram showing lateral aberration of the entire optical system of Example 11;

FIG. 47 is a cross-sectional view of the visual display device of Example 12 taken along the rotationally symmetrical axis;

FIG. 48 is a plan view of FIG. 47;

FIG. 49 is a diagram showing lateral aberration of the entire optical system of Example 12;

FIG. 50 is a cross-sectional view of the visual display device of Example 13 taken along the rotationally symmetrical axis;

FIG. 51 is a plan view of FIG. 50;

FIG. 52 is a diagram showing lateral aberration of the entire optical system of Example 13;

FIG. 53 is a cross-sectional view of the visual display device of Example 14 taken along the rotationally symmetrical axis;

FIG. 54 is a plan view of FIG. 53;

FIG. 55 is a diagram showing lateral aberration of the entire optical system of Example 14;

FIG. 56 is a cross-sectional view of the visual display device of Example 15 taken along the rotationally symmetrical axis;

FIG. 57 is a plan view of FIG. 56;

FIG. 58 is a diagram showing lateral aberration of the entire optical system of Example 15;

FIG. 59 is a diagram showing lateral aberration of the entire optical system of Example 15;

FIG. 60 is a cross-sectional view of the visual display device of Example 16 taken along the rotationally symmetrical axis;

FIG. 61 is a plan view of FIG. 60;

FIG. 62 is a diagram showing lateral aberration of the entire optical system of Example 16;

FIG. 63 is a diagram showing lateral aberration of the entire optical system of Example 16;

FIG. 64 is a cross-sectional view of the visual display device of Example 17 taken along the rotationally symmetrical axis;

FIG. 65 is a plan view of FIG. 64;

FIG. 66 is a diagram showing lateral aberration of the entire optical system of Example 17; and

FIG. 67 is a diagram showing lateral aberration of the entire optical system of Example 17.

### DESCRIPTION OF THE PREFERRED EMBODIMENTS

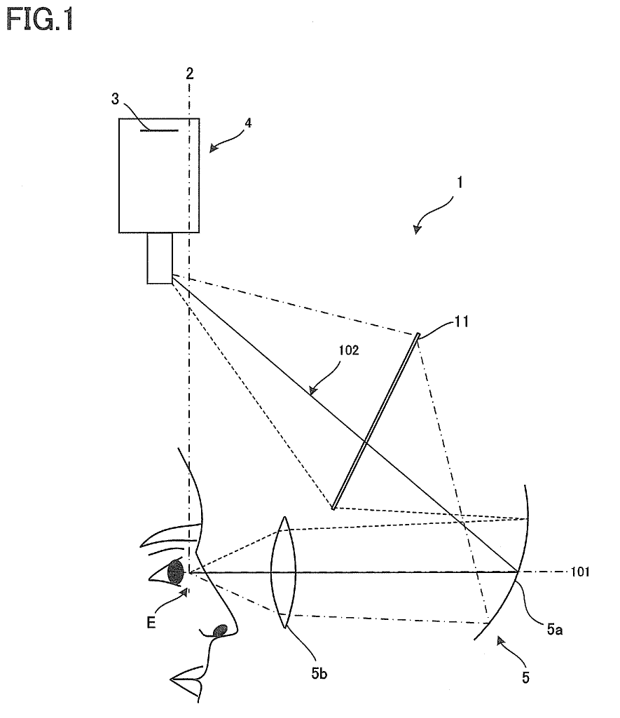

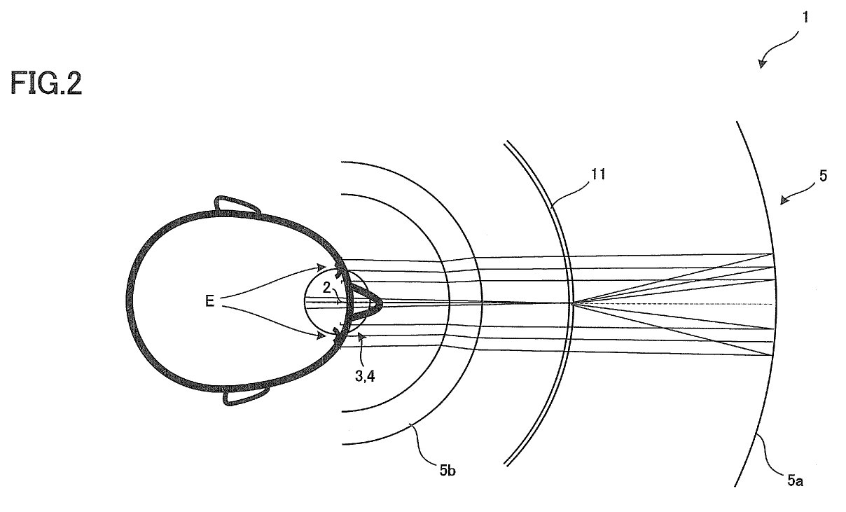

A visual display device of the present embodiments will be described below based on specific examples. FIG. 1 is a conceptual view of a visual display device 1 according to a first embodiment, and FIG. 2 is a plan view of FIG. 1.

As shown in FIGS. 1 and 2, the visual display device 1 of the first embodiment has an image display element 3, a projection optical system 4 that projects an image displayed on the image display element 3, a diffusion surface 11 disposed in the vicinity of the image projected by the projection optical system 4, and an ocular optical system 5 that allows a viewer to observe the image projected by the projection optical system 4 as a virtual image in a remote location. The ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and a second cross-section which is perpendicular to the first cross-section and includes the visual axis 101.

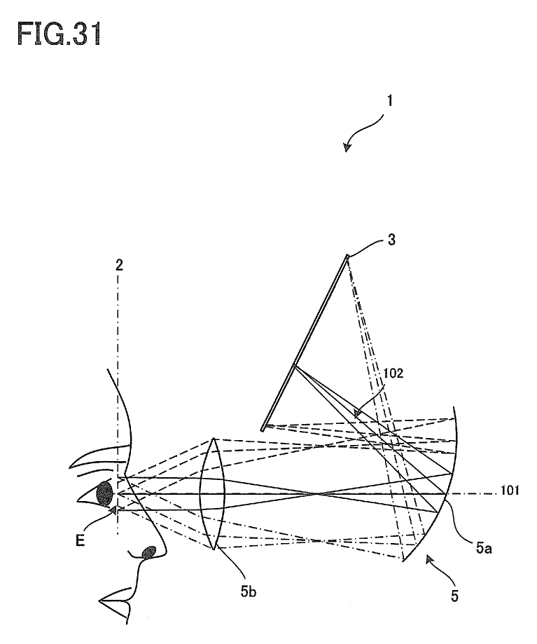

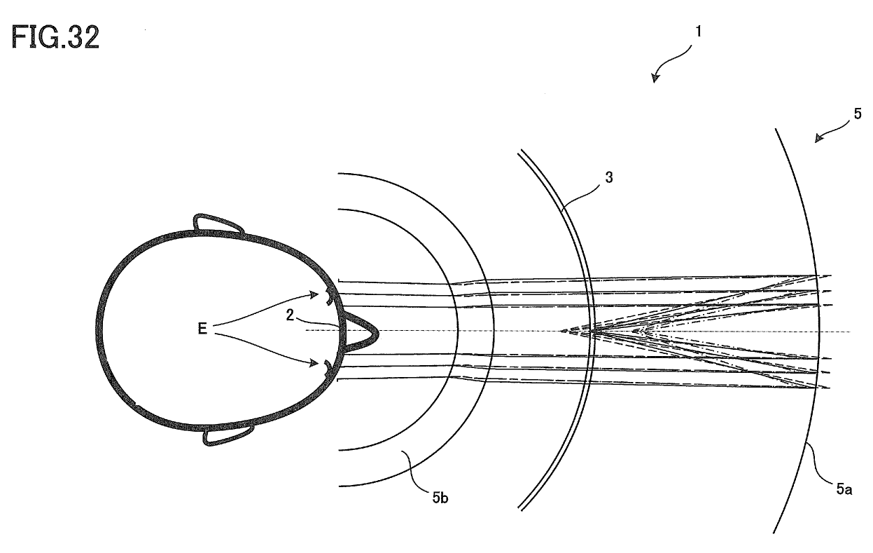

FIG. 31 is a conceptual view of a visual display device 1 according to a second embodiment, and FIG. 32 is a plan view of FIG. 31.

As shown in FIGS. 31 and 32, the visual display device 1 of the second embodiment has an image display element 3 having a curved surface and an ocular optical system 5 that allows a viewer to observe an image displayed on the image display element 3 as a virtual image in a remote location. The ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and a second cross-section which is perpendicular to the first cross-section and includes the visual axis 101.

In general, when the observation viewing angle is widened to ensure a long eye relief, the size of an observation apparatus is increased. Thus, the light path is folded to solve the above disadvantage; however, it was not possible to widen the observation viewing angle due to interference between the light paths. In particular, when the light flux diameter of the projection optical system 4 is reduced and the diffusion surface 11 is used to reduce a burden on the projection optical system 4, the diffusion surface 11 and light flux interfere with each other so that the observation viewing angle cannot be widened.

In the present embodiments, the number of times of image formation in the ocular optical system 5 is made different between in the first cross-section including the visual axis 101 and in the second cross-section which is perpendicular to the first cross-section and includes the visual axis 101 to achieve convergence of the light path, thereby avoiding the problem of interference between the light paths. With this configuration, an observation viewing angle of about 180° can be achieved. Further, an image is relayed once only in one cross-section, so that interference between the observation light path and the diffusion surface 11 or interference between the head, etc., of a viewer and the light flux is eliminated, allowing an image with a viewing angle of as wide as 50° both in the up and down directions to be observed.

Preferably, the number of times of image formation is 0 in the first cross-section and 1 in the second cross-section. With this configuration, the size of the eccentric light path can be reduced to minimum, allowing a small-sized visual display device to be provided.

Preferably, the reflection optical element 5a and the transmission optical element 5b each have a stronger refractive index in the direction toward the second cross-section. By making powerful cross-section directions coincide with each other, it is possible to obtain an intermediate image at the intermediate portion between the reflection optical element 5a and the transmission optical element 5b, the image formed only in one cross-section direction.

Preferably, the reflection optical element 5a and the transmission optical element 5b are each rotationally symmetric with respect to one rotationally symmetrical axis 2. With this configuration, it is possible to significantly increase productivity, allowing an inexpensive ocular optical system 5 to be provided.

Preferably, the second cross-section includes the rotationally symmetrical axis 2. It is important that one image formation is made in the ocular optical system 5 in the cross-section having the rotationally symmetrical axis 2 and no image formation is made in the cross-section perpendicular to the rotationally symmetrical axis 2. In the cross-section perpendicular to the rotationally symmetrical axis 2, the power of the transmission surface of the optical system is substantially 0, and power is given only to the reflection surface, so that it is not preferable to increase the times of image formation in this cross-section in terms of aberration correction. On the other hand, power can be given to the surface comparatively freely in the cross-section having the rotationally symmetrical axis 2, so that aberration correction can easily be made even if one image formation is made.

Preferably, the reflection optical element 5a is eccentric with respect to the visual axis 101 in the second cross-section. It is possible to freely set the shape of the surface in the cross-section having the rotationally symmetrical axis 2. Thus, the reflection optical element 5a is disposed eccentric with respect to this cross-section and eccentric aberration occurring due to the eccentricity can be corrected in an arbitrary surface.

Preferably, the visual axis 101 and the rotationally symmetrical axis 2 are perpendicular to each other. By disposing the rotationally symmetrical axis 2 in, the vertical direction with respect to the head of a viewer, it is possible to allow the viewer to observe a horizontally wide image. When the rotationally symmetrical axis 2 is set vertically, a rotationally symmetric surface extends in the horizontal direction in theory, which is favorable when a horizontal viewing angle is made wider. This corresponds to the fact that the human vision is wider in the horizontal direction than in the vertical direction.

Preferably, a projection image projected by the projection optical system 4 is concentrically disposed with respect to the rotationally symmetrical axis 2. With this configuration, the projection position of a virtual image projected in the front of the viewer by the ocular optical system 5 can be kept constant, so that the viewer can observe an observation image at a predetermined constant distance irrespective of the viewing direction and thus can always observe a clear observation image.

Preferably, the projection optical system 4 of the first embodiment is rotationally symmetric with respect to the rotationally symmetrical axis 2. By making the rotation symmetric axes 2 of the ocular optical system 5 and the projection optical system 4 coincide with each other, it is possible to prevent occurrence of a rotationally asymmetric image distortion in the intermediate image projected by the projection optical system 4. This allows the viewer to observe an observation image with less distortion.

Preferably, the image display element 3 of the second embodiment is rotationally symmetric with respect to the rotationally symmetrical axis 2. By making the rotation symmetric axes 2 of the ocular optical system 5 and the image display element 3 coincide with each other, it is possible to prevent occurrence of a rotationally asymmetric image distortion in the image displayed on the image display element 3. This allows the viewer to observe an observation image with less distortion.

Preferably, the reflection optical element 5a is a cylindrical linear Fresnel reflection element. That is, a linear Fresnel lens formed as a reflection surface is curved in a cylindrical shape, whereby the reflection surface can be obtained at a low price.

Preferably, one side and the other side of the reflection optical element 5a with respect to the visual axis 101 have different shapes in the second cross-section. Eccentric aberration occurs due to eccentricity of the reflection surface, so that it is desirable that the shape of the reflection surface be made different in the vertical direction along the center light beam in order to correct the eccentric aberration.

Preferably, the transmission optical element 5b is a curved cylindrical linear Fresnel transmission element. That is, a linear Fresnel transmission element is curved cylindrically so as to form a reflection surface, whereby transmission surface having rotationally symmetric characteristic and having power only in one cross-section can be obtained at a low price.

Preferably, one side and the other side of the transmission optical element 5b with respect to the visual axis 101 have different shapes in the second cross-section. Eccentric aberration occurs due to eccentricity of the reflection surface, so that it is desirable that the shape of the reflection surface be made different in the vertical direction along the center light beam of the transmission optical element 5b in order to correct the eccentric aberration also in the transmission optical element 5b.

Preferably, the following conditional expression (1) is satisfied:

|Ry|<|Rx| (1)

where Rx is the radius of curvature of the reflection surface of the reflection optical element in the vicinity where the reflection optical element is intersected by the visual axis in the first cross-section, and Ry is the radius of curvature of the reflection surface of the reflection optical element in the vicinity where the reflection optical element is intersected by the visual axis in the second cross-section.

When the conditional expression (1) is satisfied, the power of the reflection surface in the cross-section including the rotationally symmetrical axis 2 of the ocular optical system 5 is increased. This makes the light flux thinner, thereby obtaining an observation viewing angle wider in the vertical direction.

Preferably, the following conditional expression (2) is satisfied:

|Fy|<|Rx| (2)

where Fy is the focal length of the cross-section including the rotationally symmetrical axis of the transmission optical element, and Rx is the radius of curvature of the reflection surface of the reflection optical element in the vicinity where the reflection optical element is intersected by the visual axis in the first cross-section.

If the conditional expression (2) is not satisfied in the plane including the rotationally symmetrical axis 2 of the transmission optical element 5b, it is not possible for a viewer to observe a relay image formed by the reflection optical element 5a as a virtual image in a remote location.

More preferably, the following conditional expression (2′) is satisfied:

|Fy|<2×|Rx| (2′)

When the conditional expression (2′) is satisfied, the power of the reflection surface in the cross-section including the rotationally symmetrical axis 2 of the ocular optical system 5 is increased. This makes the light flux thinner, thereby obtaining an observation viewing angle wider in the vertical direction.

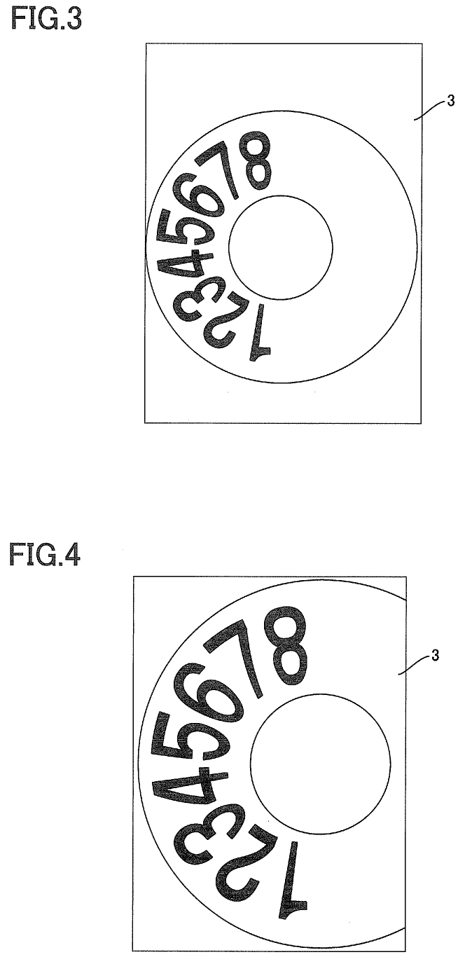

Further, as shown in FIGS. 3 and 4, the image display element 3 of the first embodiment is preferable to display an annular or a circular arc image.

In the first embodiment, a configuration in which an image surrounding the center image is projected onto the ocular optical system 5 by the projection optical system 4 is adopted, so that the shape of the display image needs to be made corresponding to this. To this end, it is necessary to display an annular or circular arc image in which the center of the annular or circular arc exists on the lower side of the observation image as shown in FIGS. 3 and 4. Alternatively, depending on the type of the projection optical system 4, it is necessary to display an annular or circular arc image in which the center of the annular or circular arc exists on the upper side of the observation image.

More preferably, in order to effectively utilize the pixels of the display element, in the case where an image corresponding to the backward of a viewer is not displayed, that is, when an image of 240 degrees is displayed, the image is displayed in substantially a semicircular form and, when an image of 120 degrees is displayed, the image is displayed in a fan-like form. Further, in order to effectively utilize the number of pixels of the image display element 3, only an observable portion of an annular or circular arc display image is enlarged for display on the image display element 3, as shown in FIG. 4.

It is possible to use a wide-angle fisheye lens as the projection optical system 4 of the first embodiment. For example, the fisheye lens of the first example disclosed in JP-B-02-014684 may be used. In addition to this type fisheye lens, a fisheye lens of a general type may be used. The point is that it is important to make the entrance pupil of the projection optical system 4 and that of the ocular optical system 5 coincide with each other.

Further, it is possible to constitute the projection optical system 4 using one convex mirror and a projection optical system 4 of a normal type.

Further, since the fisheye lens has a distortion by which an image surrounding the center image appears smaller, it is more preferable that the fisheye lens have F-θ characteristics in which lens distortion is reduced.

More preferably, in the first embodiment, a diffusion plate disclosed in JP-A-2004-102204 filed by the present applicant is used as the diffusion surface 11.

More preferably, in the first embodiment, two projection optical systems 4 corresponding to the left and right eyeballs (entrance pupils) E are arranged. In this case, it is possible to allow a viewer to observe a three-dimensional image by projecting projection images of the two projection optical systems 4 onto the diffusion surface 11 with the diffusion angle of the diffusion surface 11 controlled so that a cross-talk between the two images is not generated.

Further, it is possible to avoid a problem that the diffusion surface 11 itself is observed by a viewer by using a holographic diffusion surface as the diffusion surface 11. Further, by rotating or vibrating the diffusion surface 11, it is possible to solve the above problem.

Further, by making the ocular optical system 5 have a semi-transmissive surface, it is possible to allow the ocular optical system 5 to serve as so-called a combiner that displays an exterior image and an electron image in a superimposed manner. In this case, the combiner preferably has a configuration obtained by attaching a holographic element on an annular base plate so as to function as a concave mirror.

Further, the visual display device 1 may have a configuration in which the ocular optical system 5 is formed in an annular shape so as to allow the face of a viewer to be inserted into a center space of the ocular optical system 5. In this case, the viewer can observe an image of 360 degrees.

Although it is assumed here that a virtual image surface (object surface in the reverse raytrace) to be observed is located 2 m away from a viewer, the distance between the virtual image surface and the viewer can be set arbitrarily. Further, in the case where an observation surface is located at a finite distance, the observation surface has a cylindrical surface rotationally symmetric with respect to the rotationally symmetrical axis 2.

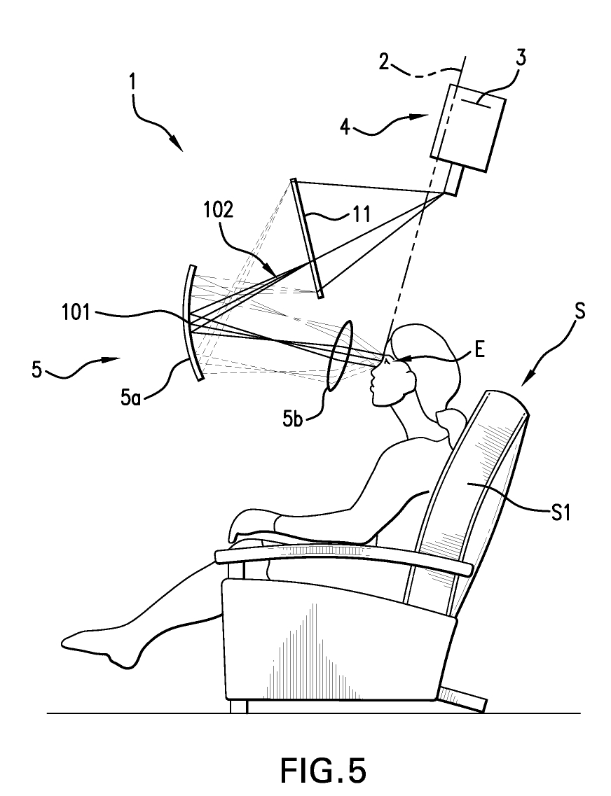

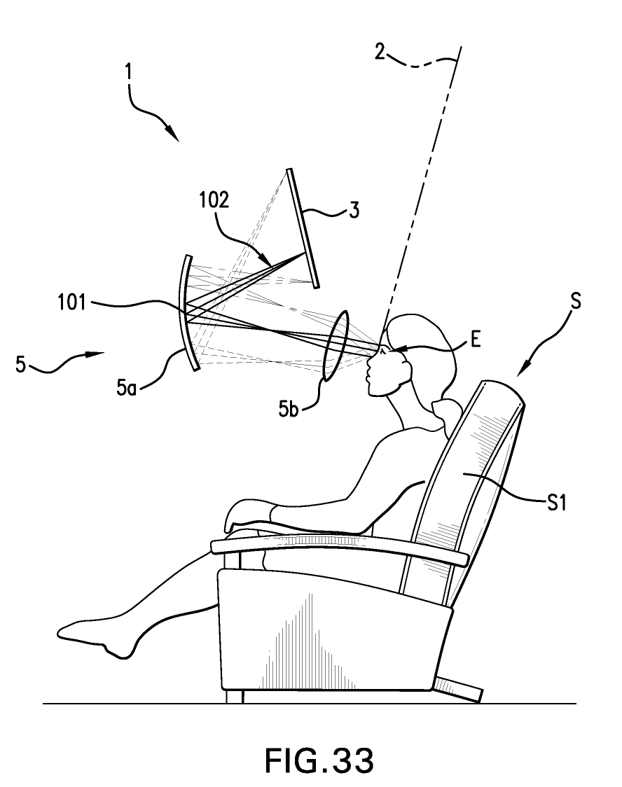

FIG. 5 is a view showing a configuration in which the visual display device 1 of the first embodiment and a seat S are combined, and FIG. 33 is a view showing a configuration in which the visual display device 1 of the second embodiment and a seat S are combined. The seat S is a sofa or seat of a type used in vehicles, and the visual display device 1 is integrally connected to the seat S. Thus, in the case where the seat S has a recliner mechanism, the angle of the visual display device 1 is changed in accordance with the angle of an inclined back rest S1 of the seat S.

Examples of an optical system of the visual display device 1 will be described below. Constructional parameters of each of the optical systems will be described later. The constructional parameters of the examples are based on a result of the reverse raytrace in which light beam passing through the entrance pupil E, which is set as the position of a viewer in the reverse raytrace of the ocular optical system 5, is directed to the diffusion surface 11 through the ocular optical system 5. Here, the projection optical system 4 is omitted.

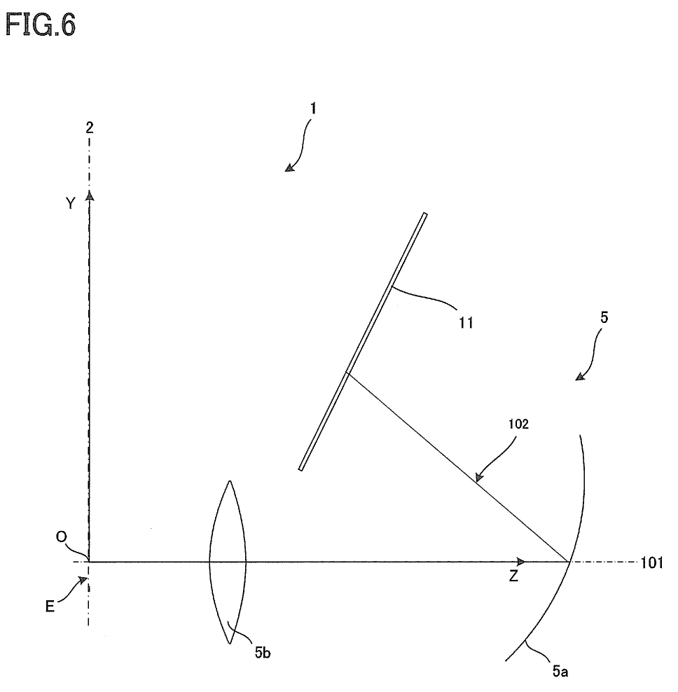

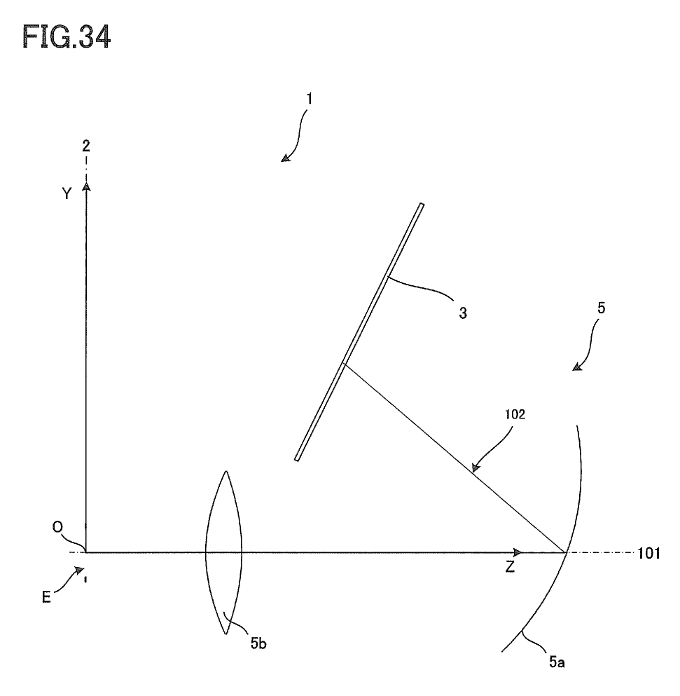

The coordinated system is defined as follows, as shown in FIG. 6 (first embodiment) and FIG. 34 (second embodiment). That is, an intersection O between the rotationally symmetrical axis 2 of the ocular optical system 5 and the visual axis 101 connecting the entrance pupil E and reflection optical element 5a is set as an origin O of an eccentric optical surface of an eccentric optical system, the direction going from the origin O of the rotationally symmetrical axis 2 of the ocular optical system 5 toward the diffusion surface side is set as a Y-axis positive direction, the direction going to the right from the origin O is set as a Z-axis positive direction, the paper surfaces of FIG. 6 and FIG. 34 are each set as a Y-Z plane, and the axis constituting a right-handed orthogonal coordinate system with the Y- and Z-axes is set as a X-axis positive direction.

Given for the eccentric surface are the amount of eccentricity of that surface from the center of the origin of the optical system on a coordinate system on which that surface is defined (X, Y and Z are indicative of the X-axis direction, the Y-axis direction, and the Z-axis direction, respectively), and the angles of tilt (α, β, and γ (°)) of the coordinate systems for defining the surfaces having the X-axis, Y-axis, and Z-axis of a coordinate system defined at the origin of the optical system as the center axes. In that case, the positive for α and β means counterclockwise rotation with respect to the positive directions of the respective axes, and the positive for γ means clockwise rotation with respect to the positive direction of the Z-axis. Referring here to how to perform α-, β- and γ-rotations of the center axis of the surface, the coordinate system that defines each surface is first α-rotated counterclockwise about the X-axis of the coordinate system that is defined at the origin of the optical system. Then, the coordinate system is β-rotated counterclockwise about the Y-axis of the rotated new coordinate system. Finally, the coordinate system is y-rotated clockwise about the Z-axis of the rotated new another coordinate system.

When, of optical surfaces forming the optical system of each example, a specific surface and the subsequent surface form together a coaxial optical system, there is a surface spacing given. Besides, the radius of curvature of each surface and the refractive index and Abbe number of the medium are given as usual.

An extended rotation free-form surface is a rotationally symmetric surface given by the following definition.

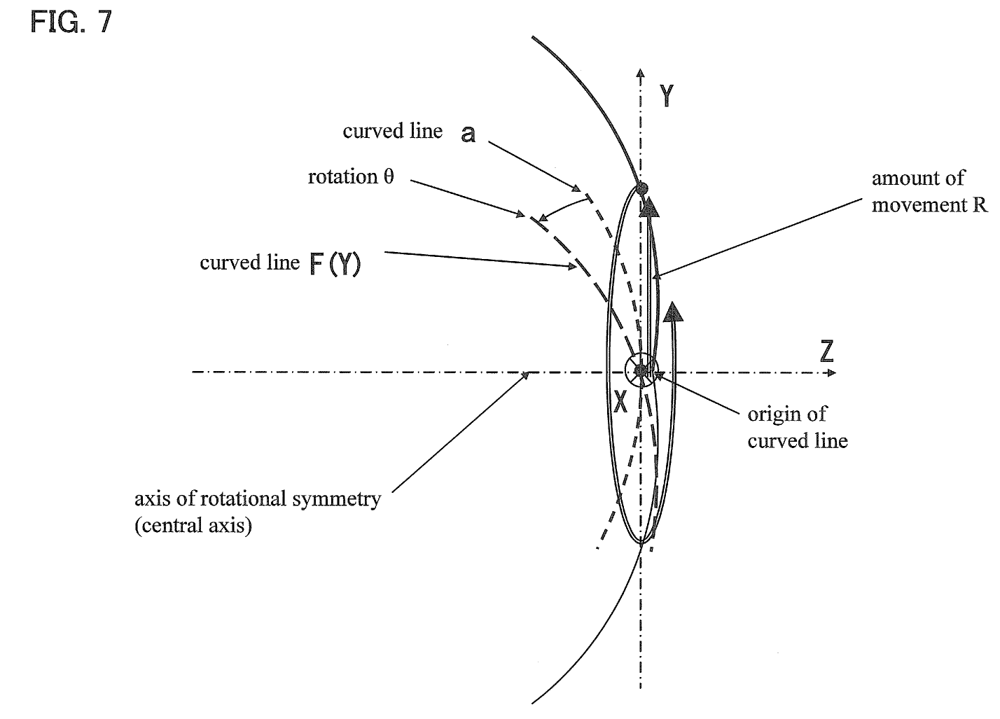

First, as shown in FIG. 7, the following curve (a) passing through the origin on the Y-Z coordinate plane is determined.

Z=(Y²/RY)/[1+{1−(C₁+1)Y²/RY²}^{1/2}]+C₂Y+C₃Y²+C₄Y³+C₅Y⁴+C₆Y⁵+C₇Y⁶+ . . . +C₂₁Y²⁰+ . . . Cₙ₊₁Yⁿ+ (a)

Then, a curve F(Y) is determined by the rotation through an angle θ (°) of that curve (a) in the X-axis positive direction provided that the counterclockwise direction is taken as positive. This curve F(Y), too, passes through the origin on the Y-Z coordinate plane.

That curve F(Y) is parallel translated by a distance R in the Y-positive direction (in the Y-negative direction when R is negative), and the parallel translated curve is then rotated about the Z-axis to generate a rotationally symmetric surface by which the extended rotation free-form surface is defined.

As a result, the extended rotation free-form surface becomes a free-form surface (free-form curve) in the Y-Z plane, and a circle with a radius |R| in the X-Z plane.

From this definition, the Z-axis becomes the axis (rotationally symmetrical axis) of the extended rotation free-form surface.

Here, RY is the radius of curvature of the spherical term in the Y-Z cross-section, C₁ is a conical constant, and C₂, C₃, C₄, C₅, are the aspheric coefficients of first, second, third, fourth, and subsequent order, respectively.

Note that a conical surface having the Z-axis as the center axis is given as one of the extended rotation free-form surface, wherein RY=∞, C₁, C₂, C₃, C₄, C₅, . . . =0 is satisfied, θ is set as (angles of tilt of the conical surface), and R is set as (radius of the bottom surface in X-Z plane).

Further, note that the term on which no data are mentioned in the constructional parameters, given later, is zero. Refractive indices and Abbe numbers are given on a d-line (587.56 nm wavelength) basis, and length in mm. The eccentricity of each surface is given in terms of the amount of eccentricity from the reference surface. The width between both eyes of a viewer is represented by X eccentricity of the aperture stop (60 mm width in a light path diagram of the horizontal cross-section). The Fresnel surface is represented by a refractive index of 1001, and diffractive optical element (DOE) is represented by a refractive index of 1077.05 and Abbe number of −3.5.

The DOE typified by a zone plate has large inverse dispersion characteristics in which Abbe number νd is −3.45 and has a high chromatic aberration correcting performance.

Further, a manufacturing process of a DOE having an aspherical effect is the same as that of a DOE having a spherical effect, so that the aspherical effect can aggressively be given to the DOE, thereby effectively correcting an increase in off-axis aberration due to widening of the viewing angle. In this case, when the aspherical effect (pitch distribution) whose power becomes smaller than the paraxial power of the spherical system as the DOE is away from the optical axis is given to the DOE, the aberration correcting performance is increased. Such pitch distribution increases the pitch around the effective diameter of the DOE, so that the manufacturability of the DOE is enhanced. Further, unlike refractive lens, the DOE can be obtained only by forming a diffractive surface on the surface of the substrate, so that the volume/weight thereof is not virtually increased, which is favorable as the optical system of the visual display device.

Examples 1 to 7 of the first embodiment will be described.

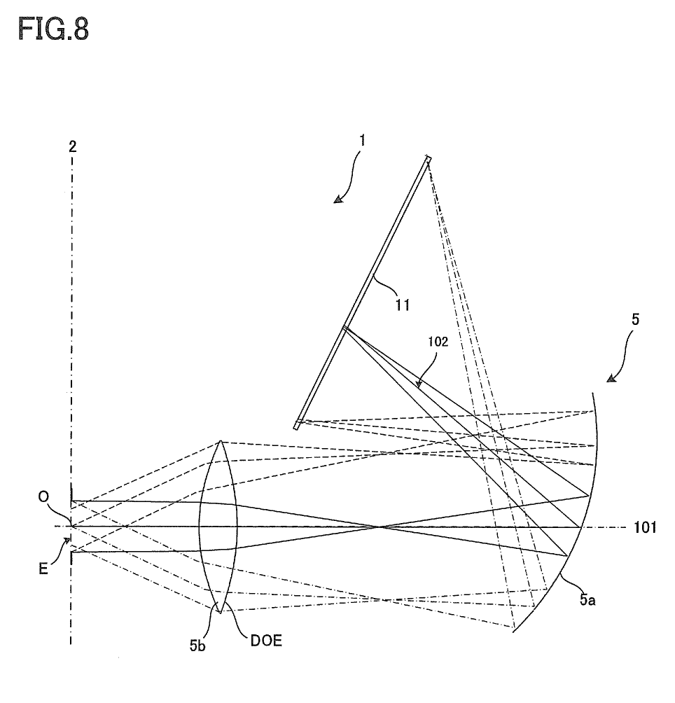

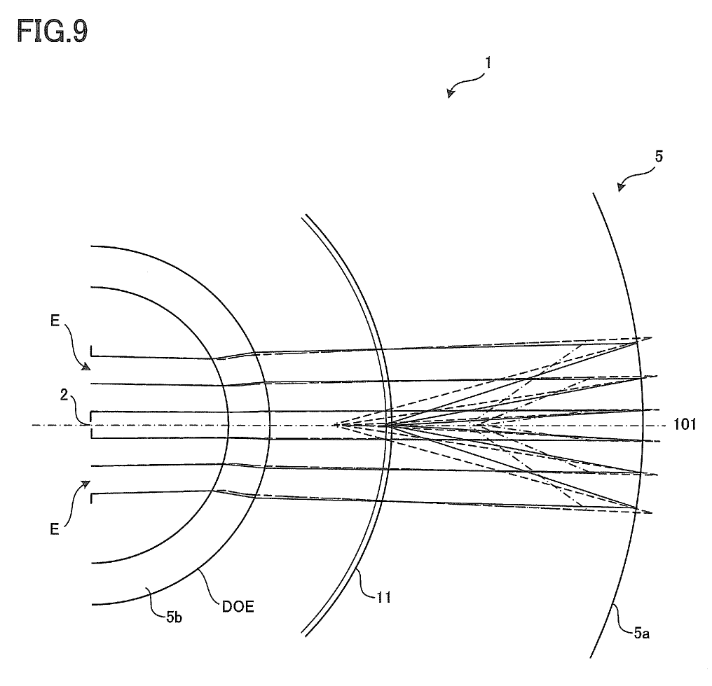

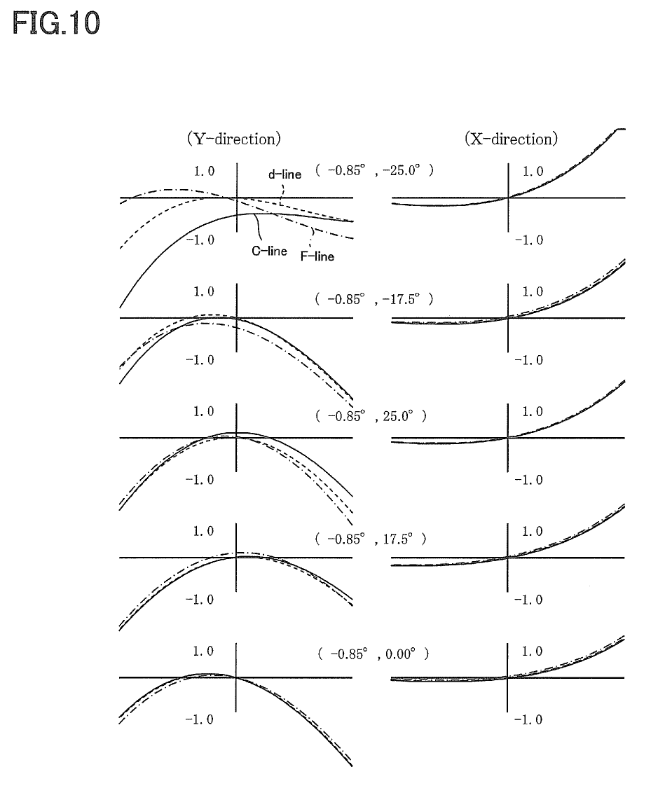

FIG. 8 is a cross-sectional view of the visual display device 1 of Example 1 taken along the rotationally symmetrical axis 2 of the ocular optical system 5, FIG. 9 is a plan view of FIG. 8, and FIG. 10 is a diagram showing lateral aberration of the entire optical system.

In the visual display device of Example 1 including a diffusion surface 11 disposed in the vicinity of an image projected by a not-shown projection optical system, and the ocular optical system 5 that allows a viewer to observe the image projected by the not-shown projection optical system as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The ocular optical system 5 includes the transmission optical element 5b whose both surfaces are Y-toric surfaces and the reflection optical element 5a having a vertically asymmetric extended rotation free-form surface with positive power. A diffractive optical element (DOE) is formed on the transmission optical element 5b at the opposite side of the entrance pupil E.

The diffusion surface 11 has a conical surface and the image projected by the not-shown projection optical system is projected in the vicinity of the diffusion surface 11 in a cone shape.

In the reverse raytrace, light flux emitted from the entrance pupil E is passed through the transmission optical element 5b of the ocular optical system 5, reflected by the reflection optical element 5a, and intermediately imaged on the diffusion surface 11. The light flux emitted from the diffusion surface 11 enters the not-shown projection optical system and then reaches a predetermined position in a radial direction deviate from the optical axis of a not-shown image display element.

The specifications of Example 1 are as follows.

| Viewing angle (aberration representation): | 50.00° vertically |
|---|---|
| Entrance pupil diameter (reverse raytrace): | 40.00 |

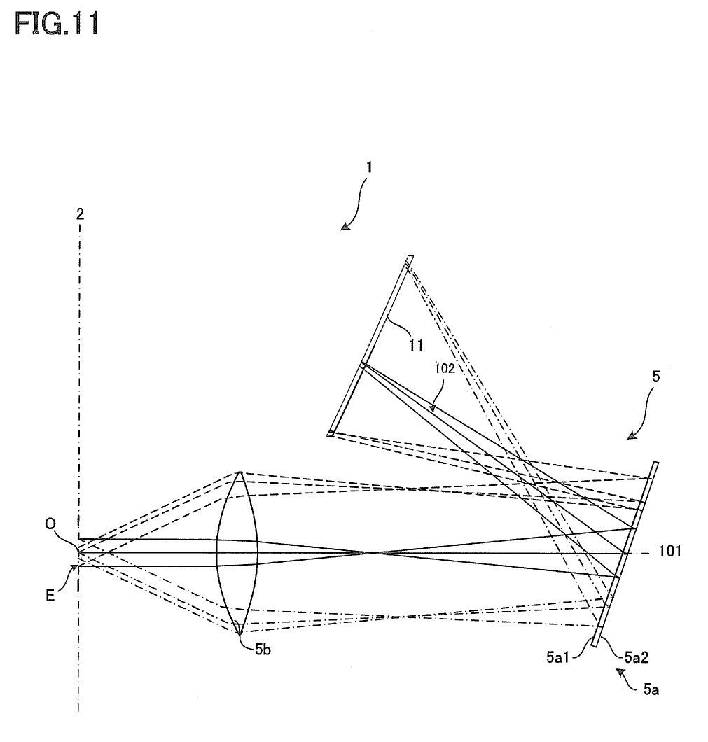

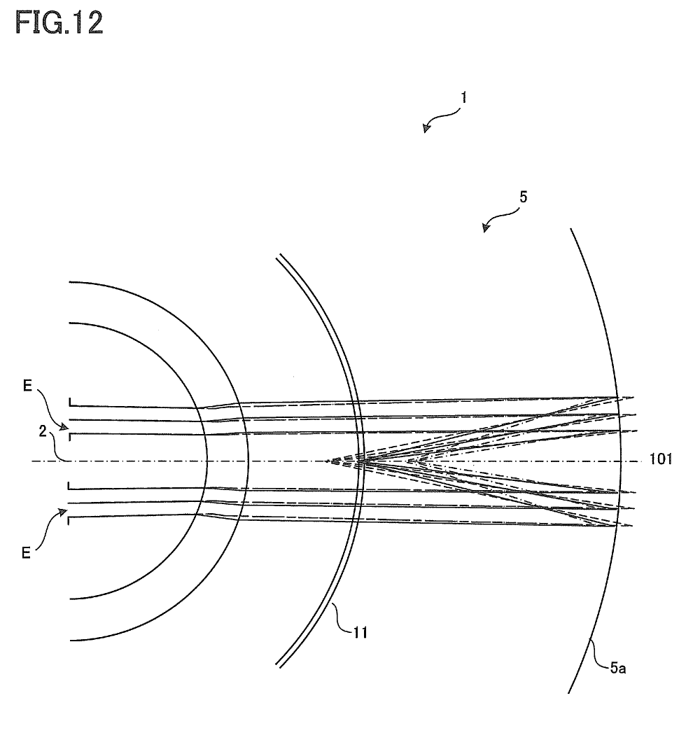

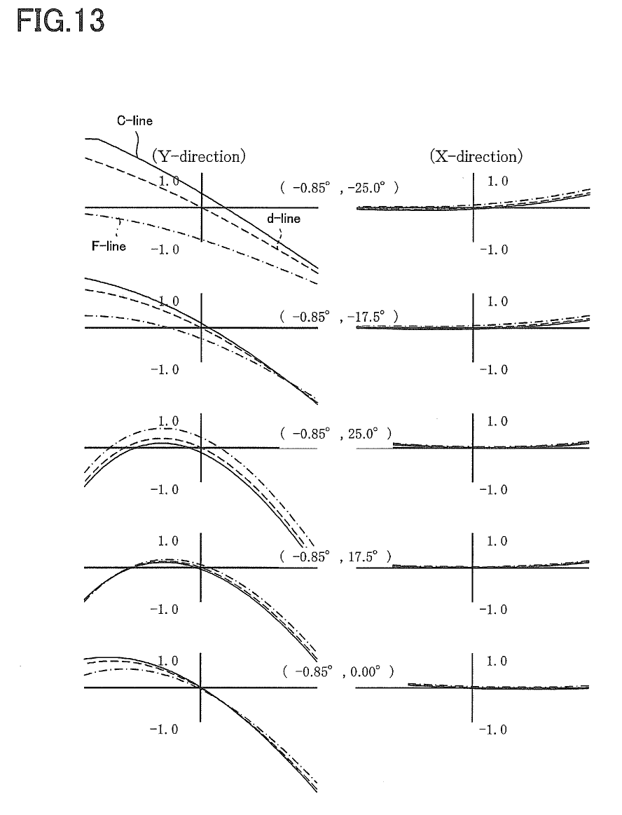

FIG. 11 is a cross-sectional view of the visual display, device 1 of Example 2 taken along the rotationally symmetrical axis 2 of the ocular optical system 5, FIG. 12 is a plan view of FIG. 11, and FIG. 13 is a diagram showing lateral aberration of the entire optical system.

In the visual display device of Example 2 including a diffusion surface 11 disposed in the vicinity of an image projected by a not-shown projection optical system, and the ocular optical system 5 that allows a viewer to observe the image projected by the not-shown projection optical system as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The ocular optical system 5 includes the transmission optical element 5b whose both surfaces are Y-toric surfaces and the reflection optical element 5a having a conical surface 5a1 on the entrance pupil E side and a Fresnel 5a2 on the opposite side of the entrance pupil E.

The diffusion surface 11 has a conical surface and the image projected by the not-shown projection optical system is projected in the vicinity of the diffusion surface 11 in a cone shape.

In the reverse raytrace, light flux emitted from the entrance pupil E is passed through the transmission optical element 5b of the ocular optical system 5, enters the conical surface 5a1 of the reflection optical element 5a, is reflected by the Fresnel 5a2, emitted from the conical surface 5a1, and intermediately imaged on the diffusion surface 11. The light flux emitted from the diffusion surface 11 enters the not-shown projection optical system and then is imaged at a predetermined radial position deviate from the optical axis of a not-shown image display element.

The specifications of Example 2 are as follows.

| Viewing angle (aberration representation): | 50.00° vertically |
|---|---|
| Entrance pupil diameter (reverse raytrace): | 20.00 |

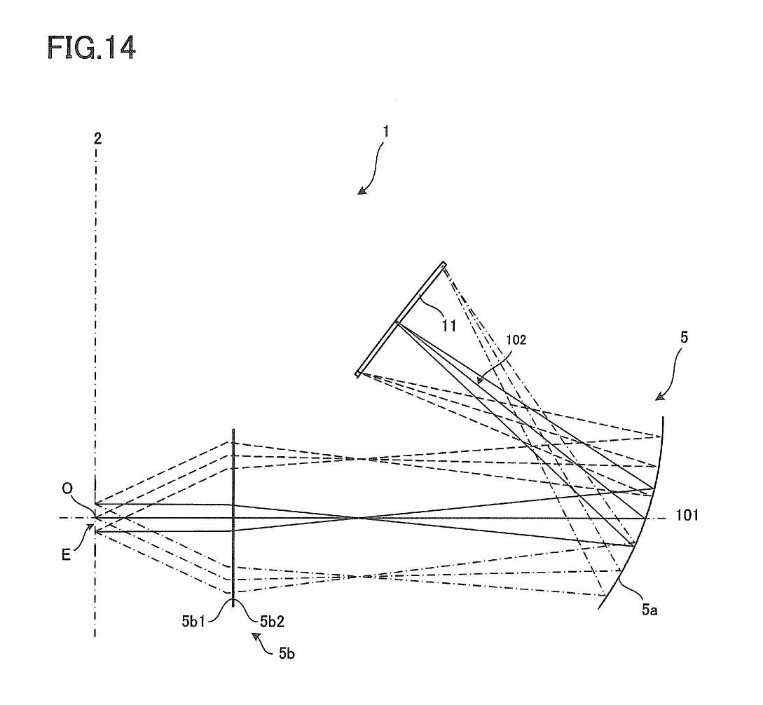

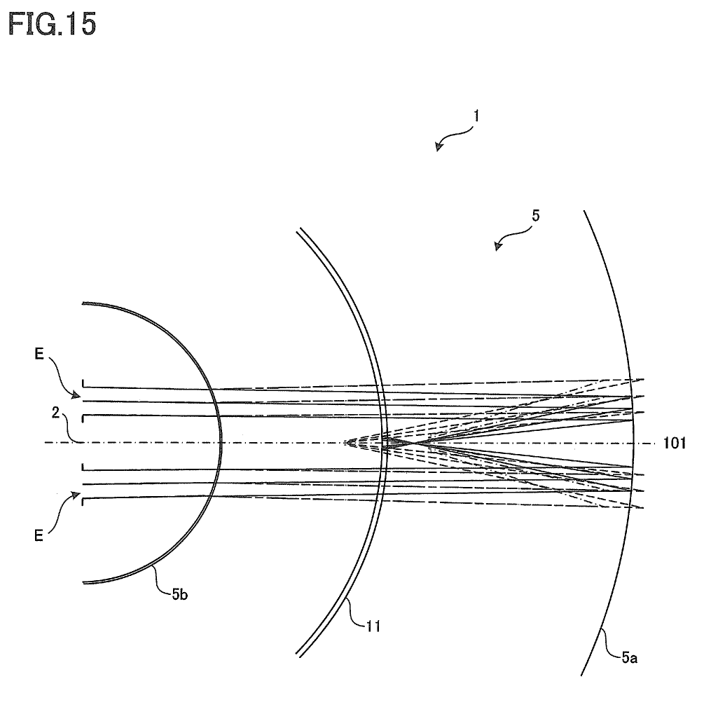

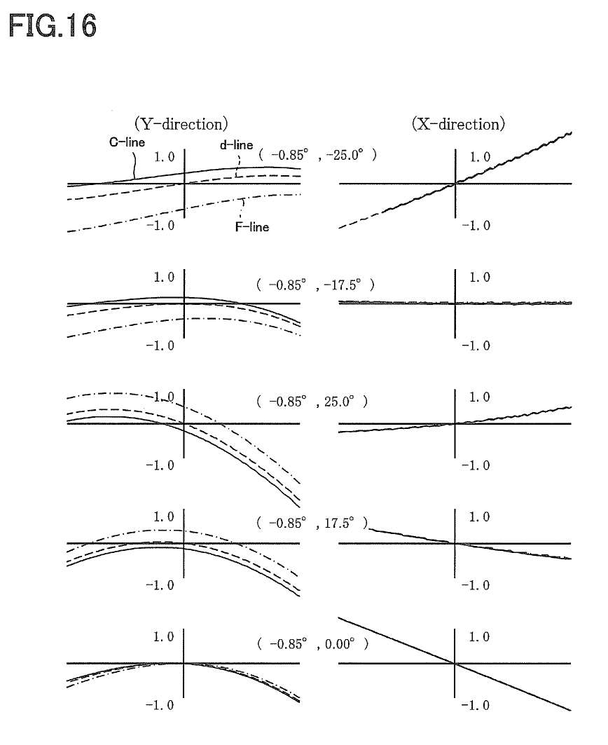

FIG. 14 is a cross-sectional view of the visual display device 1 of Example 3 taken along the rotationally symmetrical axis 2 of the ocular optical system 5, FIG. 15 is a plan view of FIG. 14, and FIG. 16 is a diagram showing lateral aberration of the entire optical system.

In the visual display device of Example 3 including a diffusion surface 11 disposed in the vicinity of an image projected by a not-shown projection optical system, and the ocular optical system 5 that allows a viewer to observe the image projected by the not-shown projection optical system as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The ocular optical system 5 includes the transmission optical element 5b having a Fresnel 5b1 on the entrance pupil E side and a cylindrical surface 5b2 on the opposite side of the entrance pupil E and the reflection optical element 5a having a vertically asymmetric extended rotation free-form surface with positive power.

The diffusion surface 11 has a conical surface and the image projected by the not-shown projection optical system is projected in the vicinity of the diffusion surface 11 in a cone shape.

In the reverse raytrace, light flux emitted from the entrance pupil E enters the Fresnel 5b1 of the transmission optical element 5b of the ocular optical system 5, emitted from the cylindrical surface 5b2, is reflected by the reflecting optical element, and intermediately imaged on the diffusion surface 11. The light flux emitted from the diffusion surface 11 enters the not-shown projection optical system and then is imaged at a predetermined radial position deviate from the optical axis of a not-shown image display element.

The specifications of Example 3 are as follows.

| Viewing angle (aberration representation): | 50.00° vertically |
|---|---|
| Entrance pupil diameter (reverse raytrace): | 20.00 |

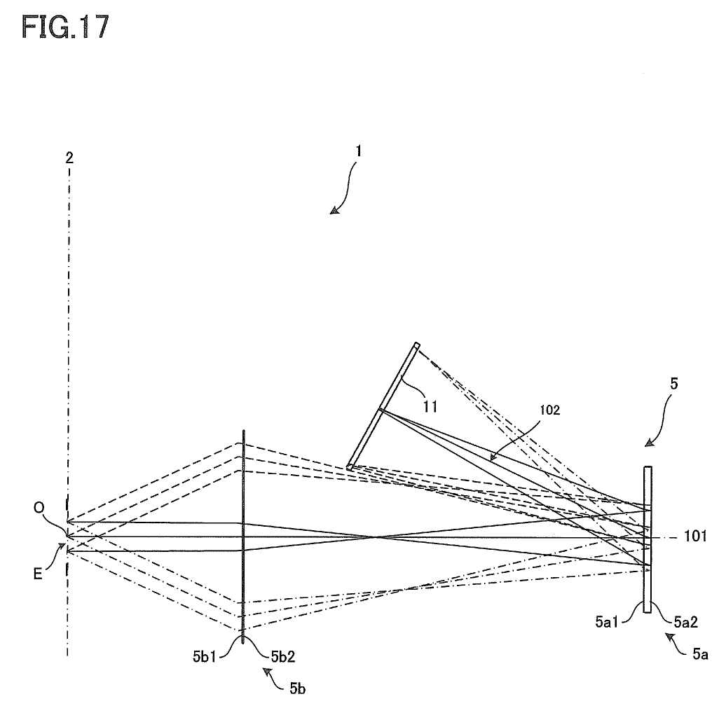

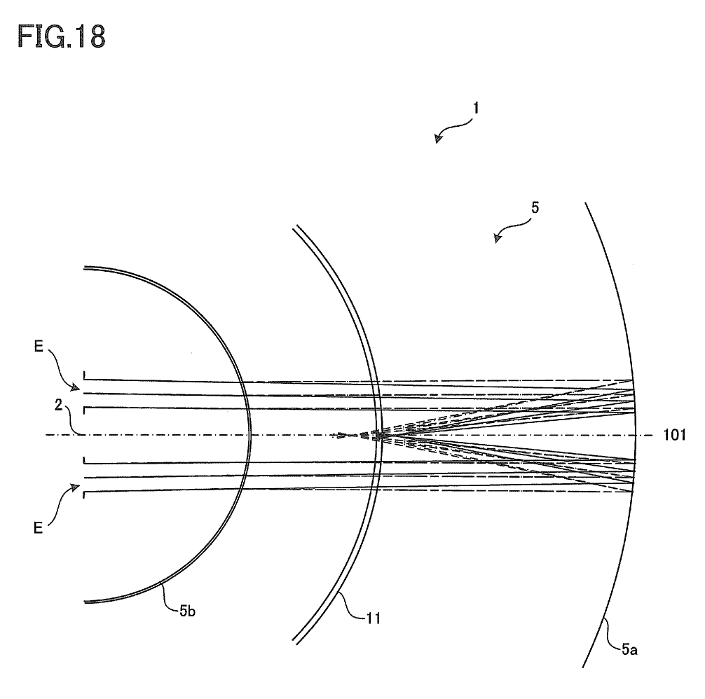

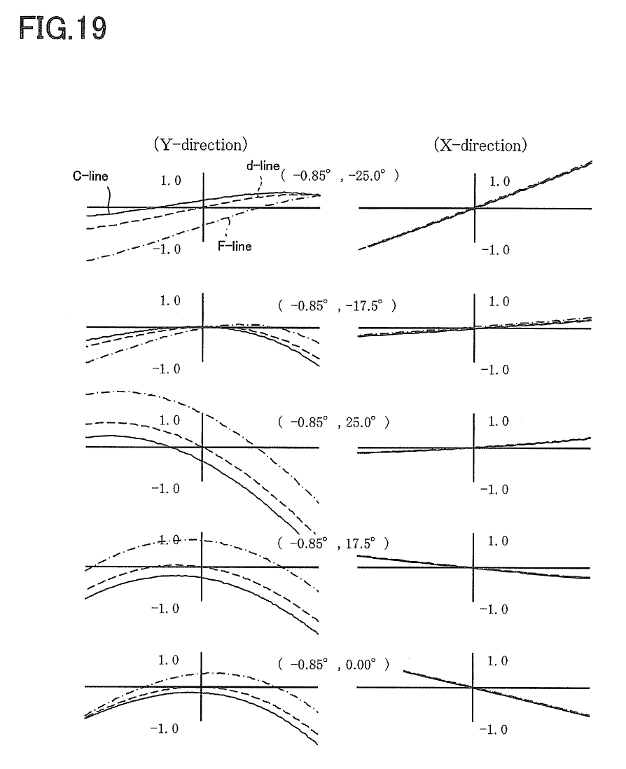

FIG. 17 is a cross-sectional view of the visual display device 1 of Example 4 taken along the rotationally symmetrical axis 2 of the ocular optical system 5, FIG. 18 is a plan view of FIG. 17, and FIG. 19 is a diagram showing lateral aberration of the entire optical system.

In the visual display device of Example 4 including a diffusion surface 11 disposed in the vicinity of an image projected by a not-shown projection optical system, and the ocular optical system 5 that allows a viewer to observe the image projected by the not-shown projection optical system as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The ocular optical system 5 includes the transmission optical element 5b having a Fresnel 5b1 on the entrance pupil E side and a cylindrical surface 5b2 on the opposite side of the entrance pupil E and the reflection optical element 5a having a cylindrical surface 5a1 on the entrance pupil E side and a Fresnel 5a2 on the opposite side of the entrance pupil E.

The diffusion surface 11 has a conical surface and the image projected by the not-shown projection optical system is projected in the vicinity of the diffusion surface 11 in a cone shape.

In the reverse raytrace, light flux emitted from the entrance pupil E enters the Fresnel 5b1 of the transmission optical element 5b of the ocular optical system 5, is emitted from the cylindrical surface 5b2, enters the cylindrical surface 5a1 of the reflection optical element 5a, is reflected by the Fresnel 5a2, emitted from the cylindrical surface 5a1, and intermediately imaged on the diffusion surface 11. The light, flux emitted from the diffusion surface 11 enters the not-shown projection optical system and then imaged at a predetermined radial position deviate from the optical axis of a not-shown image display element.

The specifications of Example 4 are as follows.

| Viewing angle (aberration representation): | 50.00° vertically |
|---|---|
| Entrance pupil diameter (reverse raytrace): | 20.00 |

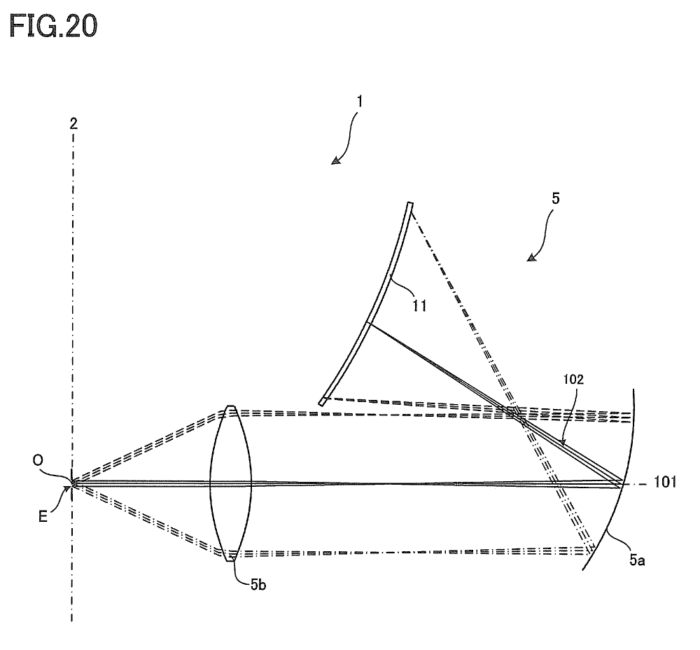

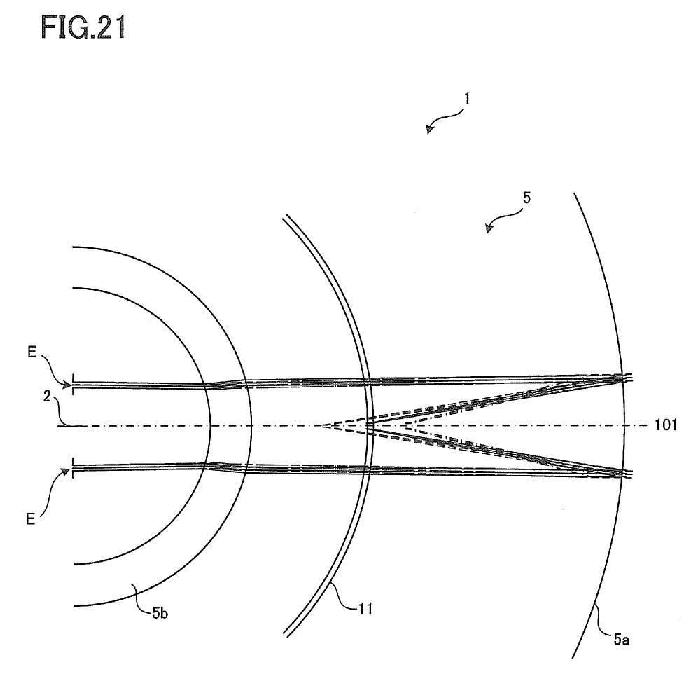

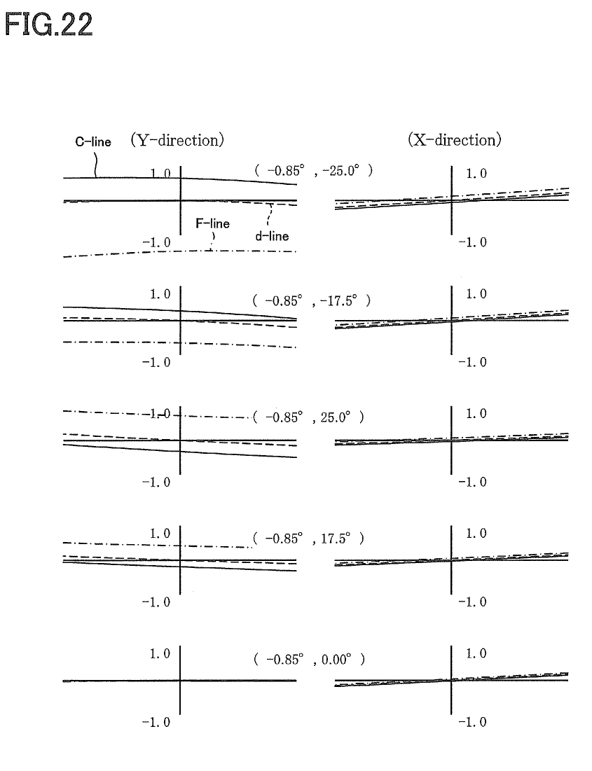

FIG. 20 is a cross-sectional view of the visual display device 1 of Example 5 taken along the rotationally symmetrical axis 2 of the ocular optical system 5, FIG. 21 is a plan view of FIG. 20, and FIG. 22 is a diagram showing lateral aberration of the entire optical system.

In the visual display device of Example 5 including a diffusion surface 11 disposed in the vicinity of an image projected by a not-shown projection optical system, and the ocular optical system 5 that allows a viewer to observe the image projected by the not-shown projection optical system as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The ocular optical system 5 includes the transmission optical element 5b whose both surfaces are Y-toric surfaces and the reflection optical element 5a having a vertically asymmetric extended rotation free-form surface with positive power.

The diffusion surface 11 has a Y-toric surface and the image projected by the not-shown projection optical system is projected in the vicinity of the diffusion surface 11.

In the reverse raytrace, light flux emitted from the entrance pupil E is passed through the transmission optical element 5b of the ocular optical system 5, reflected by the reflection optical element 5a, and intermediately imaged on the diffusion surface 11. The light flux emitted from the diffusion surface 11 enters the not-shown projection optical system and then is imaged at a predetermined radial position deviate from the optical axis of a not-shown image display element.

The specifications of Example 5 are as follows.

| Viewing angle (aberration representation): | 50.00° vertically |
|---|---|
| Entrance pupil diameter (reverse raytrace): | 4.00 |

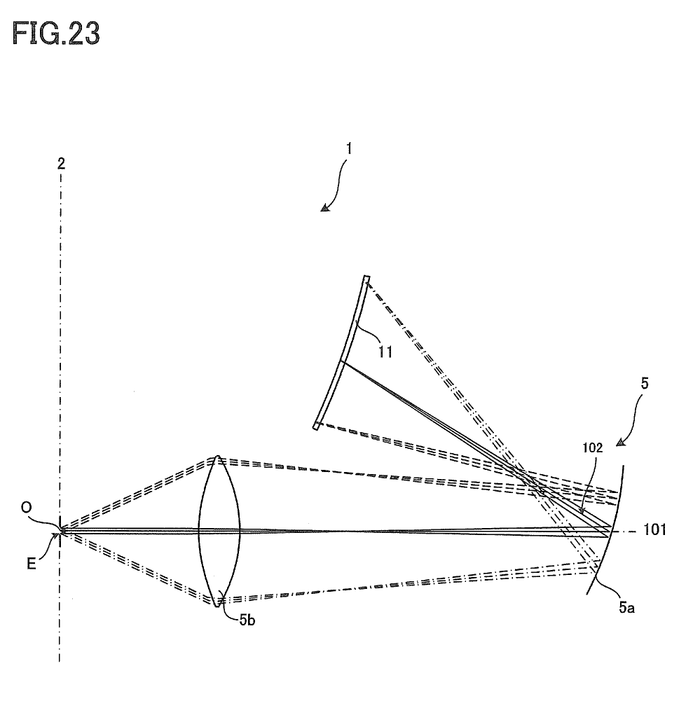

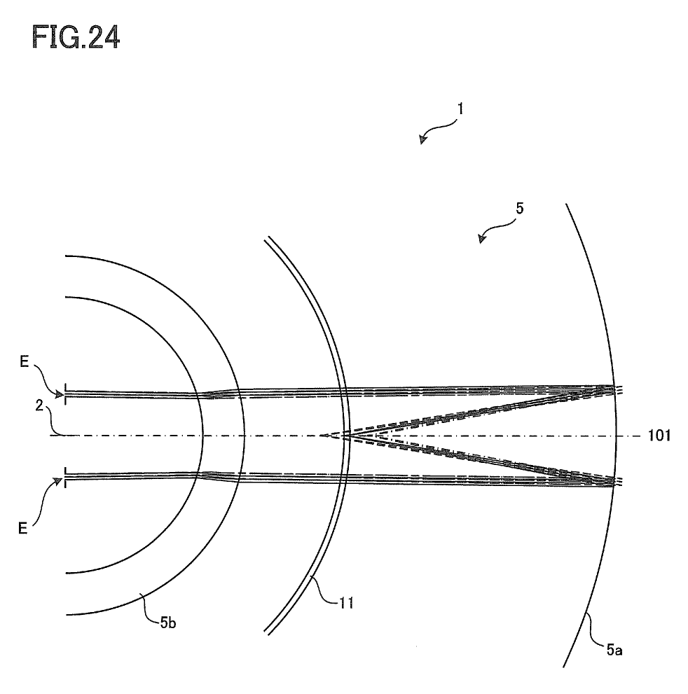

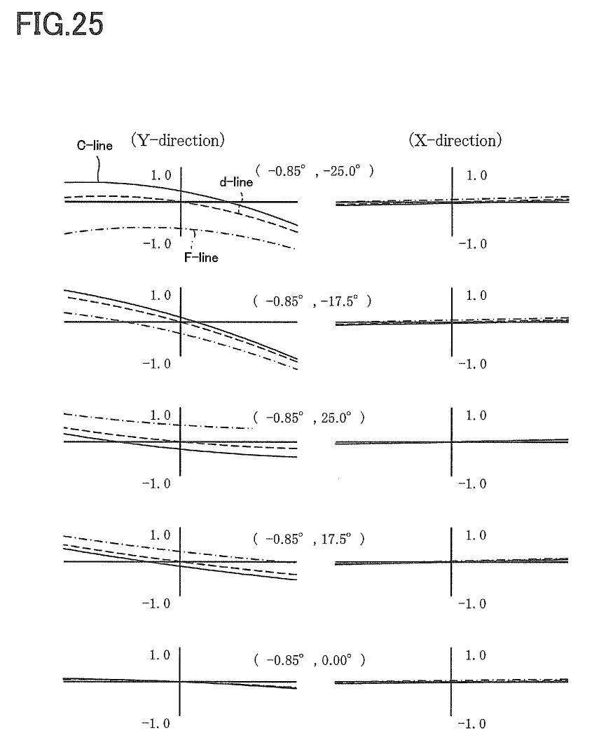

FIG. 23 is a cross-sectional view of the visual display device 1 of Example 6 taken along the rotationally symmetrical axis 2 of the ocular optical system 5, FIG. 24 is a plan view of FIG. 23, and FIG. 25 is a diagram showing lateral aberration of the entire optical system.

In the visual display device of Example 6 including a diffusion surface 11 disposed in the vicinity of and the image projected by a not-shown projection optical system, an ocular optical system 5 that allows a viewer to observe the image projected by the not-shown projection optical system as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The ocular optical system 5 includes the transmission optical element 5b whose both surfaces are Y-toric surfaces and the reflection optical element 5a having a vertically asymmetric extended rotation free-form surface with positive power.

The diffusion surface 11 has a Y-toric surface and the image projected by the not-shown projection optical system is projected in the vicinity of the diffusion surface 11.

In the reverse raytrace, light flux emitted from the entrance pupil E is passed through the transmission optical element 5b of the ocular optical system 5, reflected by the reflection optical element 5a, and intermediately imaged on the diffusion surface 11. The light flux emitted from the diffusion surface 11 enters the not-shown projection optical system and then is imaged at a predetermined radial position deviate from the optical axis of a not-shown image display element.

The specifications of Example 6 are as follows.

| Viewing angle (aberration representation): | 50.00° vertically |
|---|---|
| Entrance pupil diameter (reverse raytrace): | 4.00 |

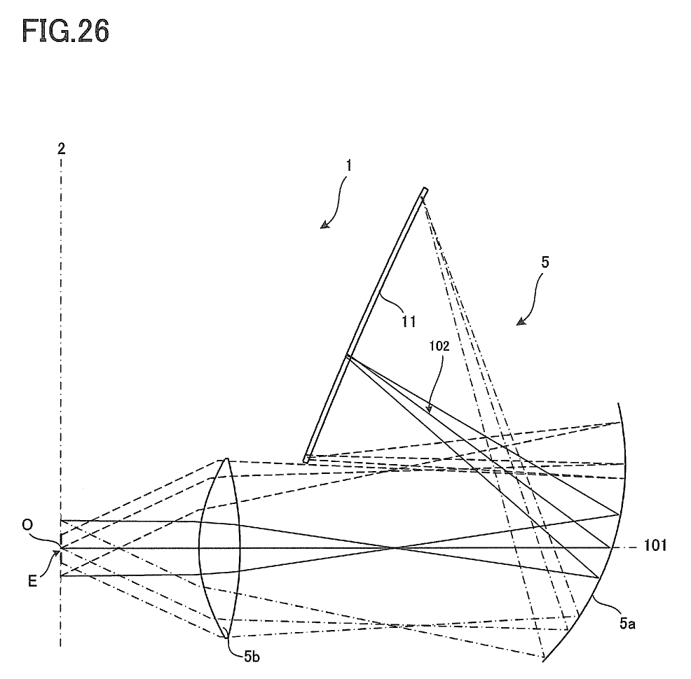

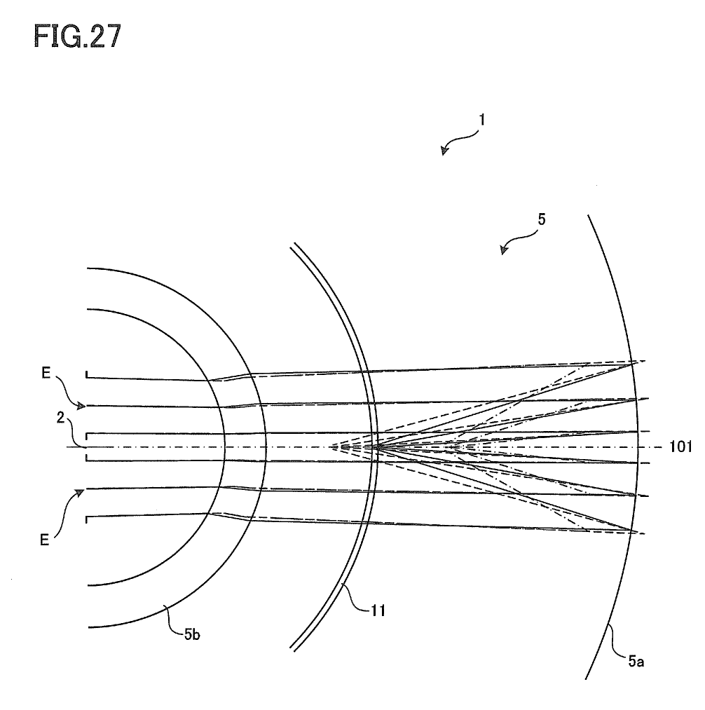

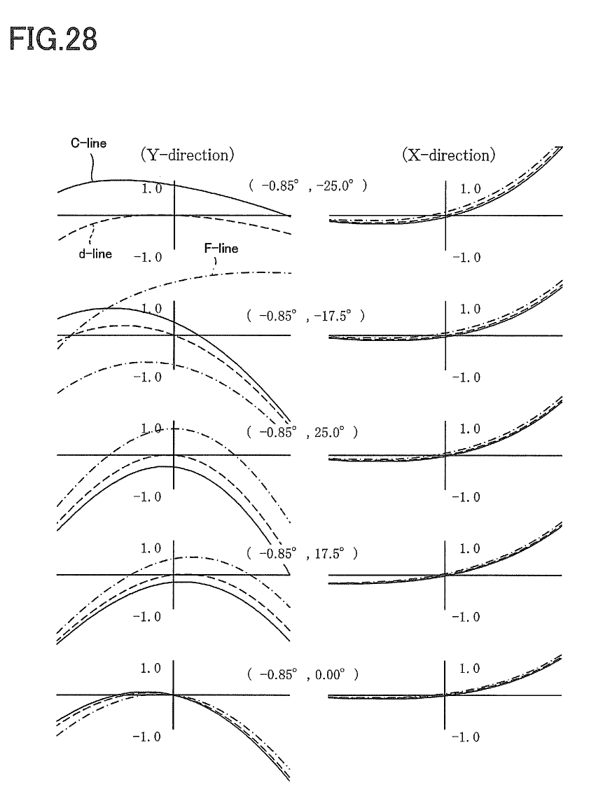

FIG. 26 is a cross-sectional view of the visual display device 1 of Example 7 taken along the rotationally symmetrical axis 2 of the ocular optical system 5, FIG. 27 is a plan view of FIG. 26, and FIG. 28 is a diagram showing lateral aberration of the entire optical system.

In the visual display device of Example 7 including a diffusion surface 11 disposed in the vicinity of an image projected by a not-shown projection optical system, and the ocular optical system 5 that allows a viewer to observe the image projected by the not-shown projection optical system as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The ocular optical system 5 includes the transmission optical element 5b whose both surfaces are Y-toric surfaces and the reflection optical element 5a having a vertically asymmetric extended rotation free-form surface with positive power.

The diffusion surface 11 has a Y-toric surface and the image projected by the not-shown projection optical system is projected in the vicinity of the diffusion surface 11.

In the reverse raytrace, light flux emitted from the entrance pupil E is passed through the transmission optical element 5b of the ocular optical system 5, reflected by the reflection optical element 5a, and intermediately imaged on the diffusion surface 11. The light flux emitted from the diffusion surface 11 enters the not-shown projection optical system and then is imaged at a predetermined radial position deviate from the optical axis of a not-shown image display element.

The specifications of Example 7 are as follows.

| Viewing angle (aberration representation): | 50.00° vertically |
|---|---|
| Entrance pupil diameter (reverse raytrace): | 40.00 |

The constructional parameters in Examples 1 to 7 are shown below, wherein the acronym “ERFS” indicates an extended rotation free-form surface. Data concerning the projection optical system 4 are omitted here.

### Example 1

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ (Entrance | 0.00 | Eccentricity (1) | | |
| | pupil) | | | | |
| 2 | ERFS (1) | 0.00 | | 1.5163 | 64.1 |
| 3 | ERFS (2) | 0.00 | | 1077.0524 | −3.5 |
| | (DOE) | | | | |
| 4 | ERFS (3) | 0.00 | | | |
| 5 | ERFS (4) | 0.00 | | | |
| | (RE) | | | | |
| 6 | ERFS (5) | 0.00 | Eccentricity (2) | 1.5163 | 64.1 |
| 7 | ERFS (6) | 0.00 | Eccentricity (2) | | |
| Image | ERFS (6) | | Eccentricity (2) | | |
| Surface | | | | | |

ERFS (1) (Y-toric surface)

| | |
|---|---|
| RY | 127.82 |
| θ | 0.00 |
| R | 100.00 |
| C1 | −2.2902E+000 |

ERFS (2) (Y-toric surface)

| | |
|---|---|
| RY | −163.00 |
| θ | 0.00 |
| R | 130.00 |
| C1 | −3.5586E+000 |

ERFS (3) (Y-toric surface)

| | |
|---|---|
| RY | −163.00 |
| θ | 0.00 |
| R | 130.00 |
| C1 | −3.5573E+000 |

ERFS (4) (Vertically asymmetric ERFS)

| | |
|---|---|
| RY | −205.41 |
| θ | −20.00 |
| R | 400.00 |
| C1 | 6.0934E−002 |
| C4 | −1.0671E−006 |

ERFS (5) (Conical surface)

| | |
|---|---|
| RY | 0.00 |
| θ | −26.28 |
| R | 217.01 |

ERFS (6) (Conical surface)

| | |
|---|---|
| RY | 0.00 |
| θ | −26.28 |
| R | 213.01 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 157.17 | Z | 0.00 |
| α | −26.28 | β | 0.00 | γ | 0.00 |

### Example 2

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ (Entrance | 0.00 | Eccentricity (1) | | |
| | pupil) | | | | |
| 2 | ERFS (1) | 0.00 | | 1.5163 | 64.1 |
| 3 | ERFS (2) | 0.00 | | | |
| 4 | ERFS (3) | 0.00 | | 1.5163 | 64.1 |
| 5 | Fresnel (1) | 0.00 | Eccentricity (2) | 1.5163 | 64.1 |
| | (RE) | | | | |
| 6 | ERFS (3) | 0.00 | | | |
| 7 | ERFS (4) | 0.00 | Eccentricity (3) | 1.5163 | 64.1 |
| 8 | ERFS (5) | 0.00 | Eccentricity (3) | | |
| Image | ERFS (5) | 0.00 | Eccentricity (3) | | |

Surface
Fresnel (1)

| | |
|---|---|
| RY | −300.00 |
| RX | −395.00 |
| SLOPE | 3.25E−001 |

The angle of inclination of the Fresnel board (A tangent for the Y-axis) is
−19.00°.

ERFS (1) (Y-toric surface)

| | |
|---|---|
| RY | 99.19 |
| θ | 0.00 |
| R | 100.00 |
| C1 | −1.5949E+000 |

ERFS (2) (Y-toric surface)

| | |
|---|---|
| RY | −110.85 |
| θ | 0.00 |
| R | 130.00 |
| C1 | −5.0616E+000 |

ERFS (3) (Conical surface)

| RY | ∞ |
|---|---|
| θ | −19.00 |
| R | 395.00 |

ERFS (4) (Conical surface)

| RY | ∞ |
|---|---|
| θ | −24.33 |
| R | 214.14 |

ERFS (5) (Conical surface)

| RY | ∞ |
|---|---|
| θ | −24.33 |
| R | 210.14 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 0.00 | Z | 400.00 |
| α | 0.00 | β | 0.00 | γ | 0.00 |

Eccentricity (3)

| | | | | | |
|---|---|---|---|---|---|
| X | 0.00 | Y | 148.55 | Z | 0.00 |
| α | 0.00 | β | 0.00 | γ | 0.00 |

### Example 3

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ (Entrance | 0.00 | Eccentricity (1) | | |
| | pupil) | | | | |
| 2 | Fresnel (1) | 0.00 | Eccentricity (2) | 1.5163 | 64.1 |
| 3 | ERFS (2) | 0.00 | | | |
| 4 | ERFS (3) | 0.00 | | | |
| | (RE) | | | | |
| 5 | ERFS (4) | 0.00 | Eccentricity (3) | 1.5163 | 64.1 |
| 6 | ERFS (5) | 0.00 | Eccentricity (3) | | |
| Image | ERFS (5) | | Eccentricity (3) | | |
| Surface | | | | | |

Fresnel (1)

| | |
|---|---|
| RY | 50.00 |
| RX | −100.00 |
| k | −1.00 |

ERFS (2) (Sylindrical surface)

| RY | ∞ |
|---|---|
| θ | 0.00 |
| R | 101.00 |

ERFS (3) (Vertically asymmetric ERFS)

| | |
|---|---|
| RY | −232.69 |
| θ | −19.00 |
| R | 400.00 |
| C1 | −2.4723E−001 |
| C4 | −1.0549E−006 |

ERFS (4) (Conical surface)

| | |
|---|---|
| RY | 0.00 |
| θ | −38.09 |
| R | 222.13 |

ERFS (5) (Conical surface)

| | |
|---|---|
| RY | 0.00 |
| θ | −38.09 |
| R | 218.13 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 0.00 | Z | 100.00 |
| α | 0.00 | β | 0.00 | γ | 0.00 |

Eccentricity (3)

| | | | | | |
|---|---|---|---|---|---|
| X | 0.00 | Y | 142.60 | Z | 0.00 |
| α | 0.00 | β | 0.00 | γ | 0.00 |

### Example 4

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ (Entrance | 0.00 | Eccentricity (1) | | |
| | pupil) | | | | |
| 2 | Fresnel (1) | 0.00 | Eccentricity (2) | 1.5163 | 64.1 |
| 3 | ERFS (1) | 0.00 | | | |
| 4 | ERFS (2) | 0.00 | | 1.5163 | 64.1 |
| 5 | Fresnel (2) | 0.00 | Eccentricity (3) | 1.5163 | 64.1 |
| | (RE) | | | | |
| 6 | ERFS (2) | 0.00 | | | |
| 7 | ERFS (3) | 0.00 | Eccentricity (4) | 1.5163 | 64.1 |
| 8 | ERFS (4) | 0.00 | Eccentricity (4) | | |
| Image | ERFS (4) | | Eccentricity (4) | | |
| Surface | | | | | |

Fresnel (1)

| | |
|---|---|
| RY | 49.70 |
| RX | −120.00 |
| k | −1.1618E+000 |

Fresnel (2)

| | |
|---|---|
| RY | −276.82 |
| RX | −400.00 |
| k | −4.0447E+000 |

ERFS (1) (Sylindrical surface)

| | |
|---|---|
| RY | 0.00 |
| θ | 0.00 |
| R | 121.00 |

ERFS (2) (Sylindrical surface)

| | |
|---|---|
| RY | 0.00 |
| θ | 0.00 |
| R | 395.00 |

ERFS (3) (Conical surface)

| | |
|---|---|
| RY | 0.00 |
| θ | −28.84 |
| R | 217.60 |

ERFS (4) (Conical surface)

| | |
|---|---|
| RY | 0.00 |
| θ | −28.84 |
| R | 213.60 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 0.00 | Z | 120.00 |
| α | 0.00 | β | 0.00 | γ | 0.00 |

Eccentricity (3)

| | | | | | |
|---|---|---|---|---|---|
| X | 0.00 | Y | 42.05 | Z | 400.00 |
| α | 0.00 | β | 0.00 | γ | 0.00 |

Eccentricity (4)

| | | | | | |
|---|---|---|---|---|---|
| X | 0.00 | Y | 77.33 | Z | 0.00 |
| α | 0.00 | β | 0.00 | γ | 0.00 |

### Example 5

| Surface | Radius | | | Refractive | Abbe |
|---|---|---|---|---|---|
| number | of curvature | Plane gap | Eccentricity | index | number |
| Object | ∞ | −2000.00 | | | |
| 1 | Stop | 0.00 | Eccentricity (1) | | |
| 2 | ERFS (1) | 0.00 | | 1.5163 | 64.1 |
| 3 | ERFS (2) | 0.00 | | | |
| 4 | ERFS (3) | 0.00 | | | |
| | (RE) | | | | |
| 5 | ERFS (4) | 0.00 | Eccentricity (2) | 1.5163 | 64.1 |
| 6 | ERFS (5) | 0.00 | Eccentricity (2) | | |
| Image | ERFS (5) | | Eccentricity (2) | | |
| Surface | | | | | |

ERFS (1) (Y-toric surface)

| | |
|---|---|
| RY | 120.00 |
| θ | 0.00 |
| R | 100.00 |
| C1 | −2.0000E+000 |

ERFS (2) (Y-toric surface)

| | |
|---|---|
| RY | −120.00 |
| θ | 0.00 |
| R | 130.00 |
| C1 | −2.0000E+000 |

ERFS (3) (Vertically asymmetric ERFS)

| | |
|---|---|
| RY | −200.00 |
| θ | −16.00 |
| R | 400.00 |
| C1 | −7.0000E−001 |
| C4 | −1.0000E−006 |

ERFS (4) (Y-toric surface)

| | |
|---|---|
| RY | −405.00 |
| θ | −25.00 |
| R | 218.92 |

ERFS (5) (Y-toric surface)

| | |
|---|---|
| RY | −400.00 |
| θ | −25.00 |
| R | 214.92 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 120.00 | Z | 0.00 |
| α | 0.00 | β | 0.00 | γ | 0.00 |

### Example 6

| Surface | Radius | | | Refractive | Abbe |
|---|---|---|---|---|---|
| number | of curvature | Plane gap | Eccentricity | index | number |
| Object | ∞ | −2000.00 | | | |
| 1 | Stop | 0.00 | Eccentricity (1) | | |
| 2 | ERFS (1) | 0.00 | | 1.5163 | 64.1 |
| 3 | ERFS (2) | 0.00 | | | |
| 4 | ERFS (3) | 0.00 | | | |
| 5 | ERFS (4) | 0.00 | Eccentricity (2) | 1.5163 | 64.1 |
| 6 | ERFS (5) | 0.00 | Eccentricity (2) | | |
| Image | ERFS (5) | | Eccentricity (2) | | |
| Surface | | | | | |

ERFS (1) (Y-toric surface)

| | |
|---|---|
| RY | 100.00 |
| θ | 0.00 |
| R | 100.00 |
| C1 | −3.6991E+000 |

ERFS (2) (Y-toric surface)

| | |
|---|---|
| RY | −100.00 |
| θ | 0.00 |
| R | 130.00 |
| C1 | −5.9467E−001 |

ERFS (3) (Vertically asymmetric ERFS)

| | |
|---|---|
| RY | −219.36 |
| θ | −16.00 |
| R | 100.00 |
| C1 | −4.3365E+000 |
| C4 | −2.0797E−006 |

ERFS (4) (Y-toric surface)

| | |
|---|---|
| RY | −513.63 |
| θ | −19.29 |
| R | 206.71 |

ERFS (5) (Y-toric surface)

| | |
|---|---|
| RY | −508.63 |
| θ | −19.29 |
| R | 202.71 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 123.41 | Z | 0.00 |
| α | 0.00 | β | 0.00 | γ | 0.00 |

### Example 7

| Surface | Radius | | | Refractive | Abbe |
|---|---|---|---|---|---|
| number | of curvature | Plane gap | Eccentricity | index | number |
| Object | ∞ | −2000.00 | | | |
| 1 | Stop | 0.00 | Eccentricity (1) | | |
| 2 | ERFS (1) | 0.00 | | 1.5163 | 64.1 |
| 3 | ERFS (2) | 0.00 | | | |
| 4 | ERFS (3) | 0.00 | | | |
| 5 | ERFS (4) | 0.00 | Eccentricity (2) | 1.5163 | 64.1 |
| 6 | ERFS (5) | 0.00 | Eccentricity (2) | | |
| Image | ERFS (5) | | Eccentricity (2) | | |
| Surface | | | | | |

ERFS (1) (Y-toric surface)

| | |
|---|---|
| RY | 104.47 |
| θ | 0.00 |
| R | 100.00 |
| C1 | −1.5027E+000 |

ERFS (2) (Y-toric surface)

| | |
|---|---|
| RY | −228.04 |
| θ | 0.00 |
| R | 130.00 |
| C1 | −3.5586E+000 |

ERFS (3) (Vertically asymmetric ERFS)

| | |
|---|---|
| RY | −200.53 |
| θ | 0.00 |
| R | 400.00 |
| C1 | −8.2605E−002 |
| C4 | −1.1141E−006 |

ERFS (4) (Y-toric surface)

| | |
|---|---|
| RY | ∞ |
| θ | −23.28 |
| R | 211.49 |

ERFS (5) (Y-toric surface)

| | |
|---|---|
| RY | ∞ |
| θ | −23.28 |
| R | 207.49 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 140.06 | Z | 0.00 |
| α | 0.00 | β | 0.00 | γ | 0.00 |

The light beam is traced with the width between both eyes of a viewer set to X30 mm in eccentricity (1) (i.e., 60 mm width in the light path).

Further, as the ray tracing method, reverse raytrace from the eyeballs of a viewer toward the diffusion surface is performed.

Values of various pieces of data in the respective Examples are shown below.

| Various | | | | |
|---|---|---|---|---|
| data | Example 1 | Example 2 | Example 3 | Example 4 |
| Ry | −205.4 | −300.0 | −232.7 | −276.8 |
| Rx | 400.0 | 400.0 | 400.0 | 400.0 |
| Fy | 140.0 | 106.6 | 101.7 | 101.1 |

| Various data | Example 5 | Example 6 | Example 7 |
|---|---|---|---|
| Ry | −200.0 | −219.4 | −200.5 |
| Rx | −400.0 | −400.0 | −400.0 |
| Fy | 121.4 | 102.1 | 143.2 |

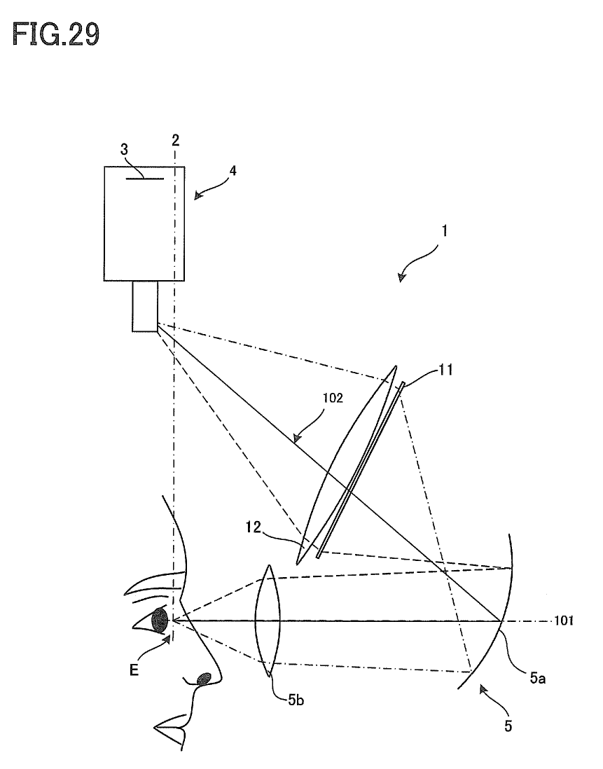

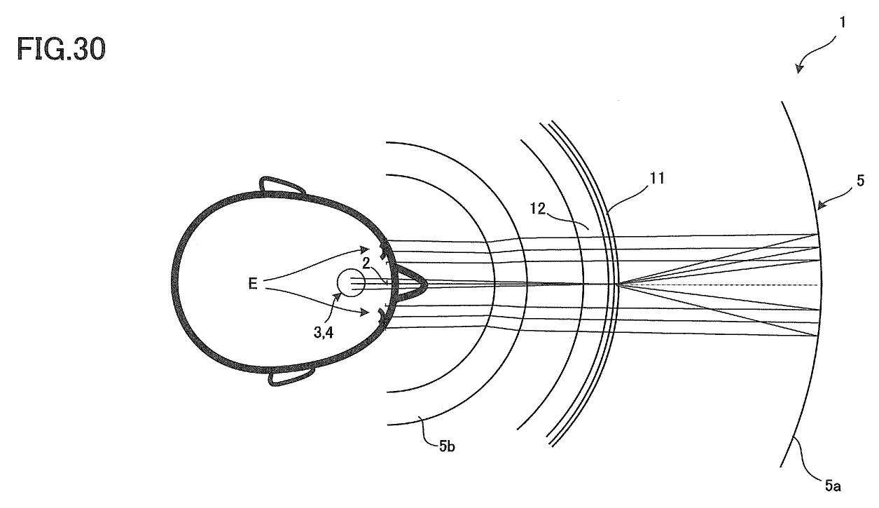

FIGS. 29 and 30 show a reference example of the first embodiment. FIG. 29 is a conceptual view of the visual display device 1 of a reference example of the first embodiment, and FIG. 30 is a plan view of FIG. 29.

In the reference example of the first embodiment, a pupil relay optical element 12 is disposed in the vicinity of the projection image so as to make an exit pupil of the projection optical system and an entrance pupil of the ocular optical system coincide with each other.

Examples 8 to 14 of the second embodiment will be described.

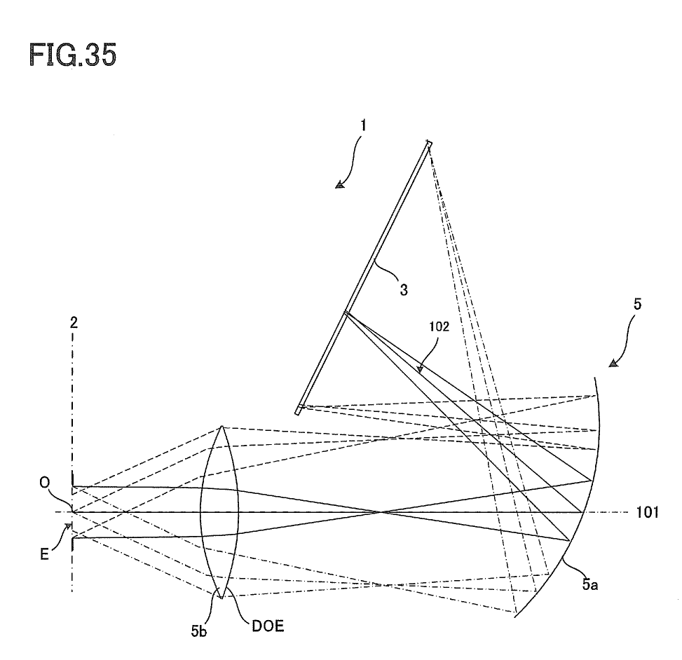

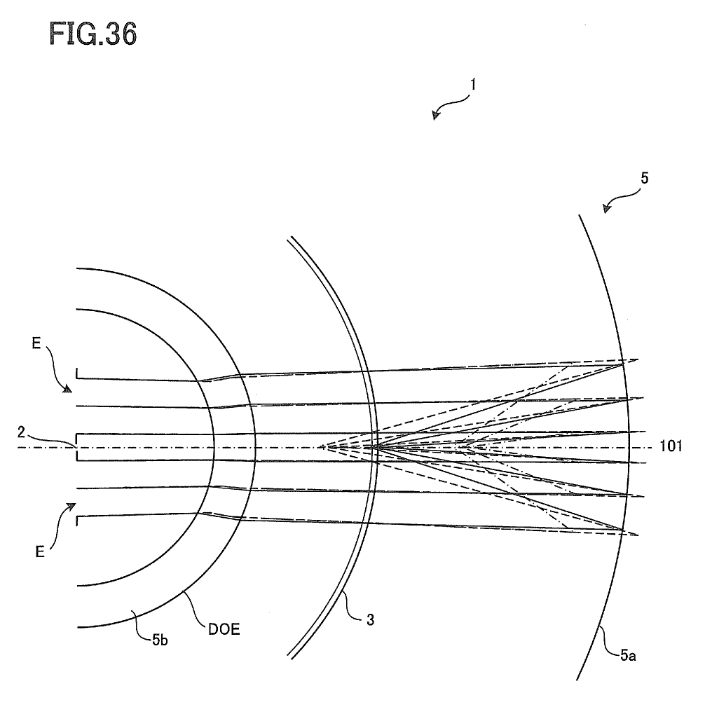

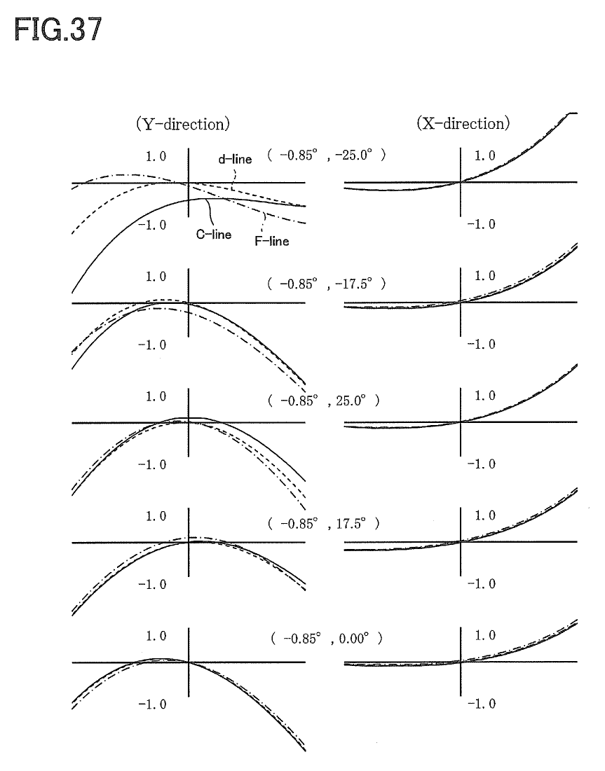

FIG. 35 is a cross-sectional view of the visual display device 1 of Example 8 taken along the rotationally symmetrical axis 2 of the ocular optical system 5, FIG. 36 is a plan view of FIG. 35, and FIG. 37 is a diagram showing lateral aberration of the entire optical system.

In the visual display device of Example 8 including an image display element 3 having a curved surface and the ocular optical system 5 that allows a viewer to observe an image displayed on the image display element 3 as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The image display element 3 has a conical surface.

The ocular optical system 5 includes the transmission optical element 5b whose both surfaces are Y-toric surfaces and the reflection optical element 5a having a vertically asymmetric extended rotation free-form surface with positive power. A diffractive optical element (DOE) is formed on the transmission optical element 5b at the opposite side of the entrance pupil E.

In the reverse raytrace, light flux emitted from the entrance pupil E is passed through the transmission optical element 5b of the ocular optical system 5, reflected by the reflection optical element 5a, and imaged on the image display element 3.

The specifications of Example 8 are as follows.

| Viewing angle (aberration representation): | 50.00° vertically |
|---|---|
| Entrance pupil diameter (reverse raytrace): | 40.00 |

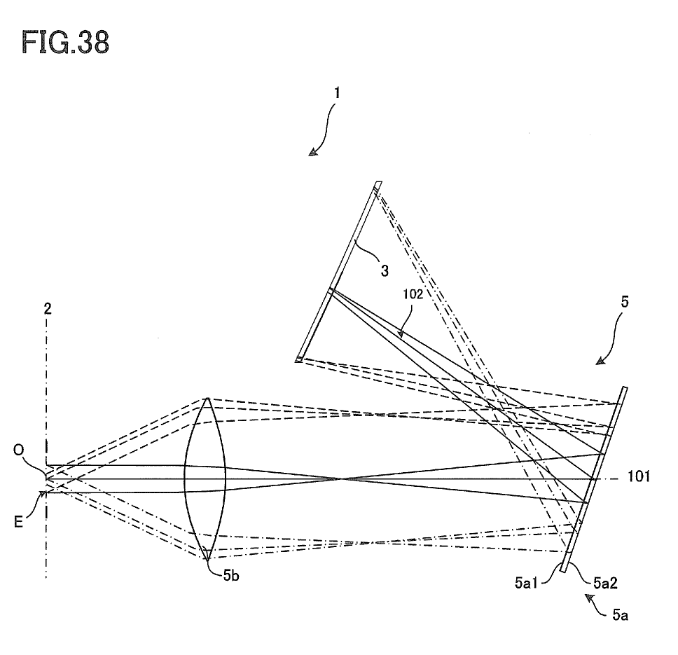

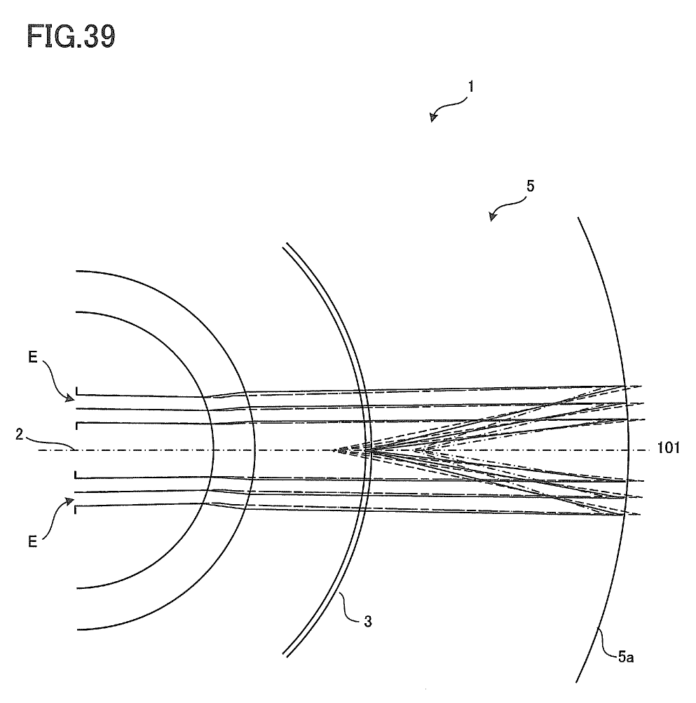

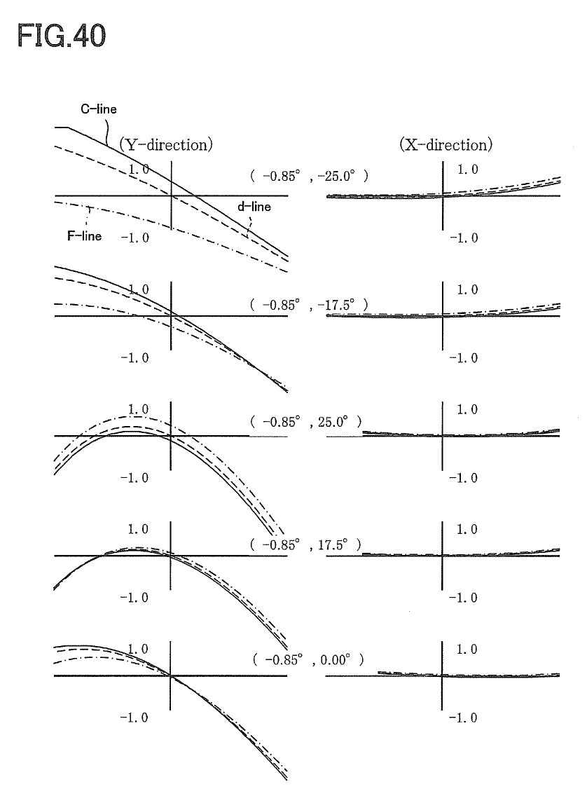

FIG. 38 is a cross-sectional view of the visual display device 1 of Example 9 taken along the rotationally symmetrical axis 2 of the ocular optical system 5, FIG. 39 is a plan view of FIG. 38, and FIG. 40 is a diagram showing lateral aberration of the entire optical system.

In the visual display device of Example 9 including an image display element 3 having a curved surface and the ocular optical system 5 that allows a viewer to observe an image displayed on the image display element 3 as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The image display element 3 has a conical surface.

The ocular optical system 5 includes the transmission optical element 5b whose both surfaces are Y-toric surfaces and reflection optical element 5a having a conical surface 5a1 on the entrance pupil E side and a Fresnel 5a2 on the opposite side of the entrance pupil E.

In the reverse raytrace, light flux emitted from the entrance pupil E is passed through the transmission optical element 5b of the ocular optical system 5, enters the conical surface 5a1 of the reflection optical element 5a, is reflected by the Fresnel 5a2, emitted from the conical surface 5a1, and imaged on the image display element 3.

The specifications of Example 9 are as follows.

| Viewing angle (aberration representation): | 50.00° vertically |
|---|---|
| Entrance pupil diameter (reverse raytrace): | 20.00 |

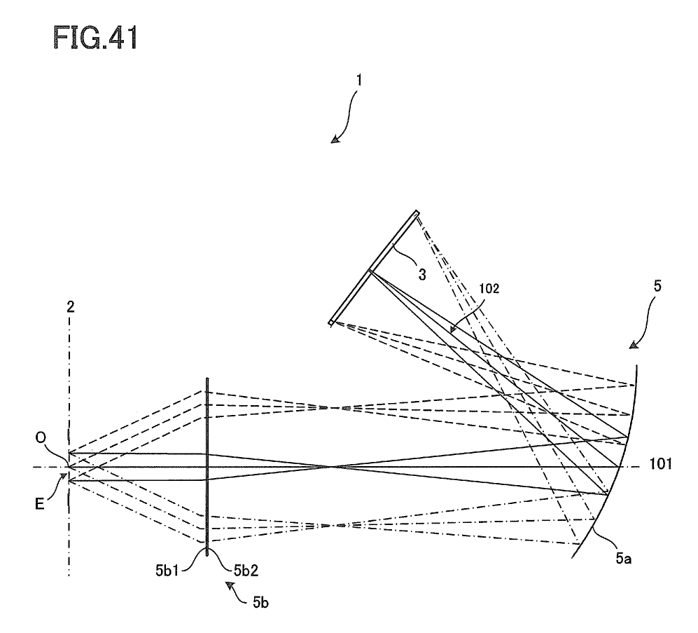

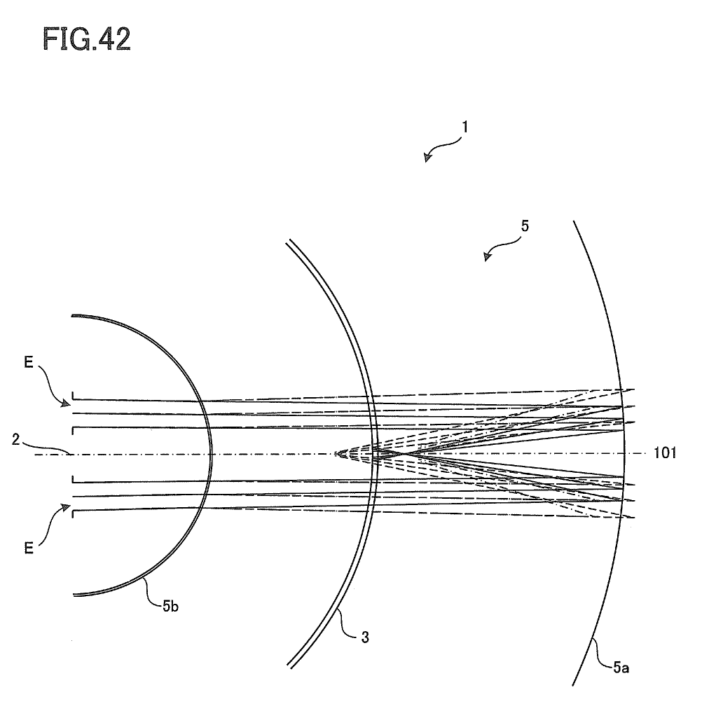

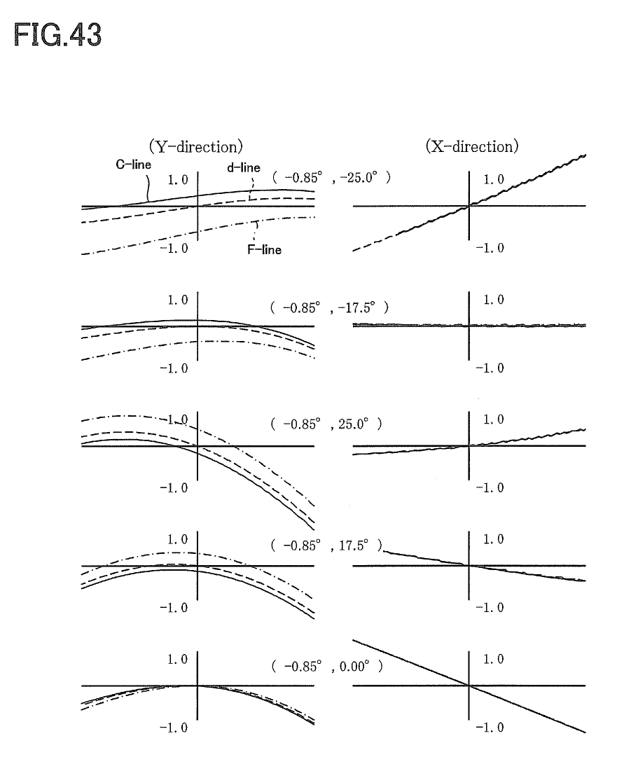

FIG. 41 is a cross-sectional view of the visual display device 1 of Example 10 taken along the rotationally symmetrical axis 2 of the ocular optical system 5, FIG. 42 is a plan view of FIG. 41, and FIG. 43 is a diagram showing lateral aberration of the entire optical system.

In the visual display device of Example 10 including an image display element 3 having a curved surface and the ocular optical system 5 that allows a viewer to observe an image displayed on the image display element 3 as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and a second cross-section which is perpendicular to the first cross-section and includes the visual axis 101.

The image display element 3 has a conical surface.

The ocular optical system 5 includes the transmission optical element 5b having a Fresnel 5b1 on the entrance pupil E side and a cylindrical surface 5b2 on the opposite side of the entrance pupil E and the reflection optical element 5a having a vertically asymmetric extended rotation free-form surface with positive power.

In the reverse raytrace, light flux emitted from the entrance pupil E enters the Fresnel 5b1 of the transmission optical element 5b of the ocular optical system 5, is emitted from the cylindrical surface 5b2, reflected by the reflection optical element, and imaged on the image display element 3.

The specifications of Example 10 are as follows.

| Viewing angle (aberration representation): | 50.00° vertically |
|---|---|
| Entrance pupil diameter (reverse raytrace): | 20.00 |

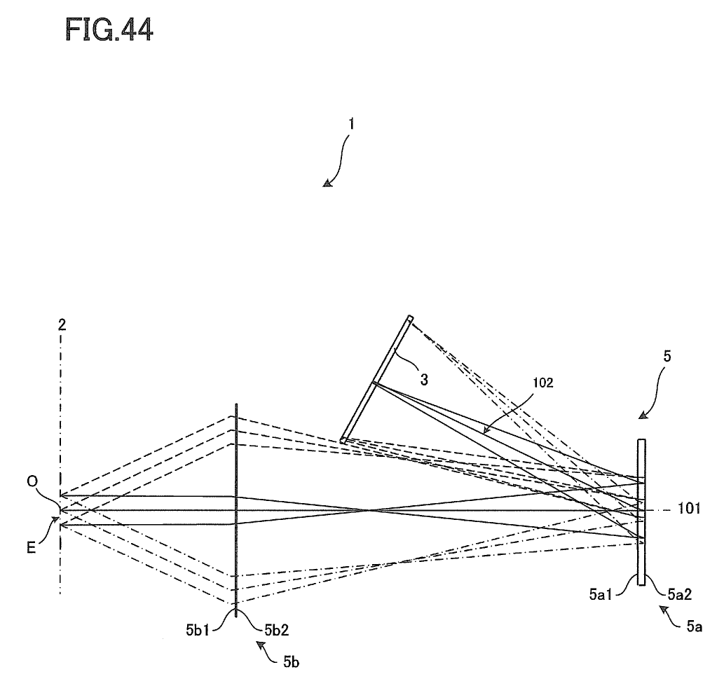

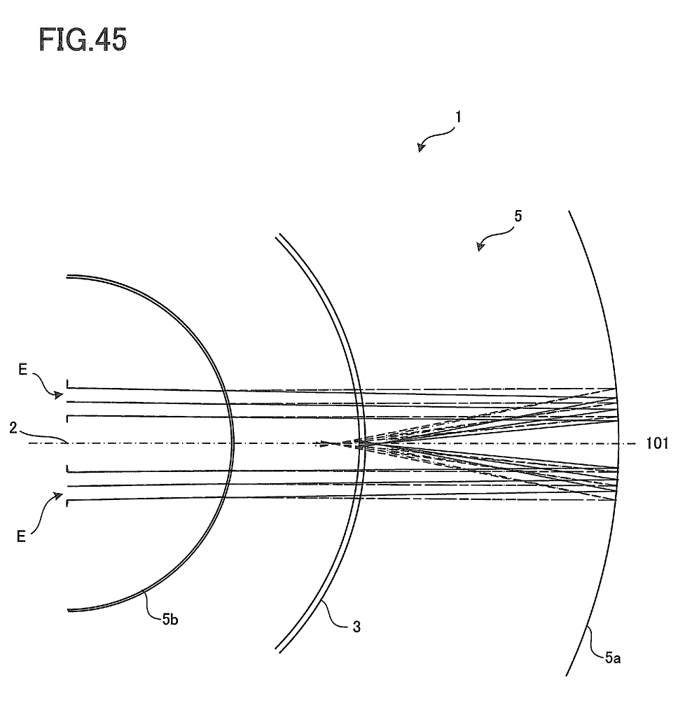

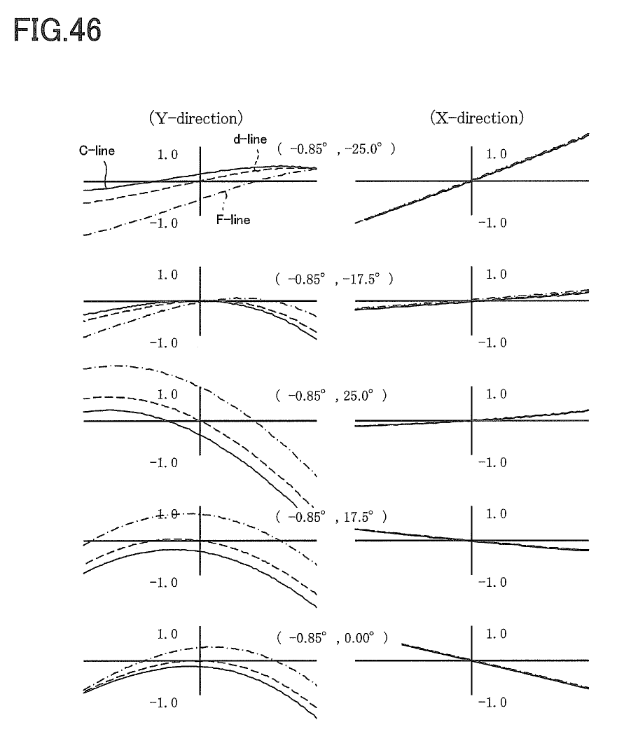

FIG. 44 is a cross-sectional view of the visual display device 1 of Example 11 taken along the rotationally symmetrical axis 2 of the ocular optical system 5, FIG. 45 is a plan view of FIG. 44, and FIG. 46 is a diagram showing lateral aberration of the entire optical system.

In the visual display device of Example 11 including an image display element 3 having a curved surface and the ocular optical system 5 that allows a viewer to observe an image displayed on the image display element 3 as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and a second cross-section which is perpendicular to the first cross-section and includes the visual axis 101.

The image display element 3 has a conical surface.

The ocular optical system 5 includes the transmission optical element 5b having a Fresnel 5b1 on the entrance pupil E side and a cylindrical surface 5b2 on the opposite side of the entrance pupil E and the reflection optical element 5a having a cylindrical surface 5a1 on the entrance pupil E side and a Fresnel 5a2 on the opposite side of the entrance pupil E.

In the reverse raytrace, light flux emitted from the entrance pupil E enters the Fresnel 5b1 of the transmission optical element 5b of the ocular optical system 5, is emitted from the cylindrical surface 5b2, enters the cylindrical surface 5a1 of the reflection optical element 5a, is reflected by the Fresnel 5a2, emitted from the cylindrical surface 5a1, and imaged on the image display element 3.

The specifications of Example 11 are as follows.

| Viewing angle (aberration representation): | 50.00° vertically |
|---|---|
| Entrance pupil diameter (reverse raytrace): | 20.00 |

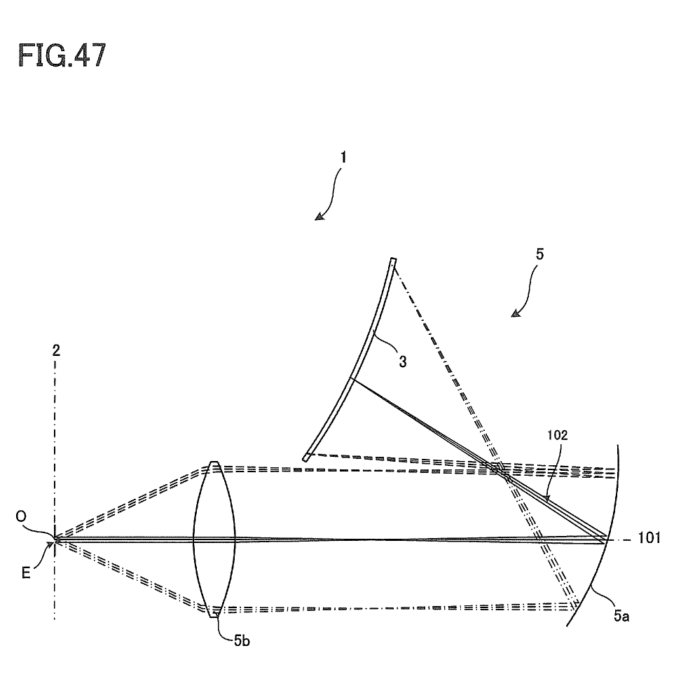

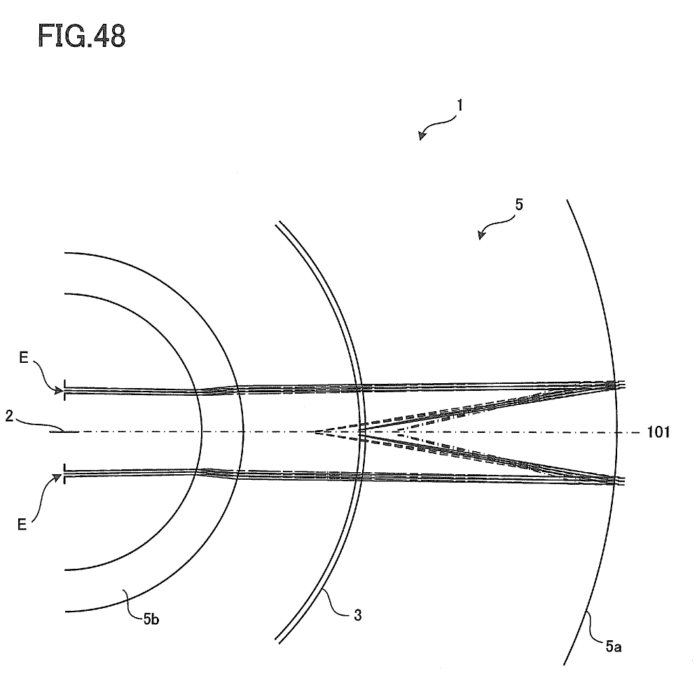

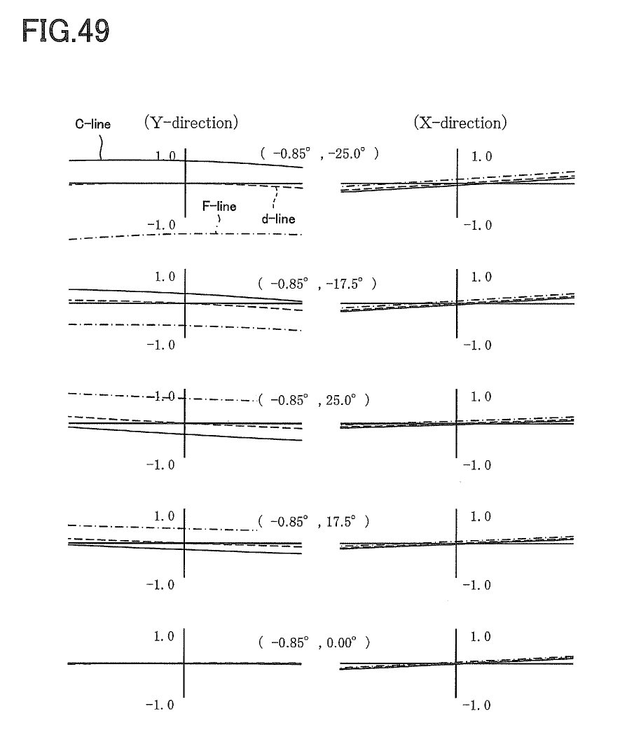

FIG. 47 is a cross-sectional view of the visual display device 1 of Example 12 taken along the rotationally symmetrical axis 2 of the ocular optical system 5, FIG. 48 is a plan view of FIG. 47, and FIG. 49 is a diagram showing lateral aberration of the entire optical system.

In the visual display device of Example 12 including an image display element 3 having a curved surface and the ocular optical system 5 that allows a viewer to observe an image displayed on the image display element 3 as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The image display element 3 has a Y-toric surface.

The ocular optical system 5 includes the transmission optical element 5b whose both surfaces are Y-toric surfaces and the reflection optical element 5a having a vertically asymmetric extended rotation free-form surface with positive power.

In the reverse raytrace, light flux emitted from the entrance pupil E is passed through the transmission optical element 5b of the ocular optical system 5, reflected by the reflection optical element 5a, and imaged on the image display element 3.

The specifications of Example 12 are as follows.

| Viewing angle (aberration representation): | 50.00° vertically |
|---|---|
| Entrance pupil diameter (reverse raytrace): | 4.00 |

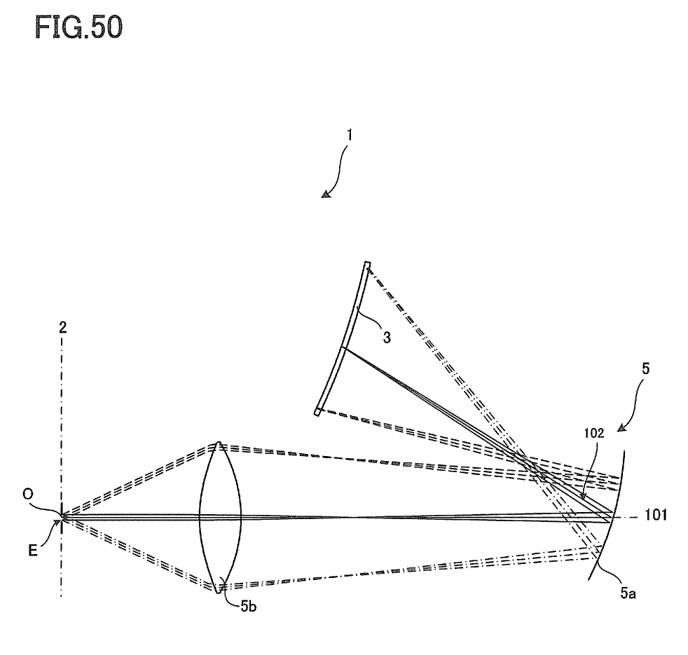

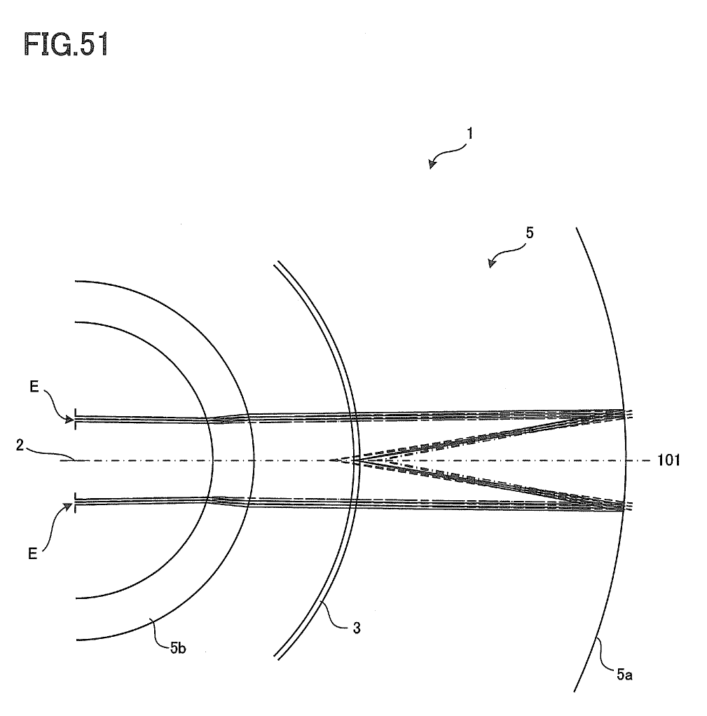

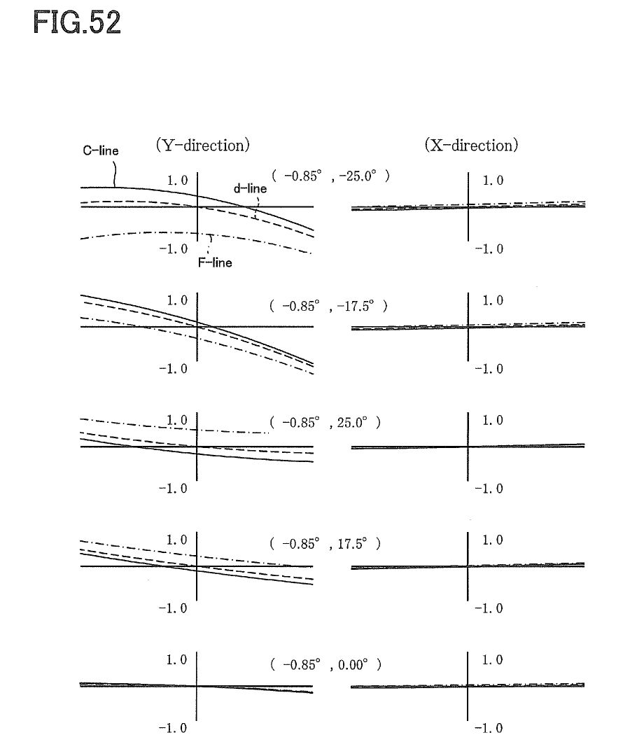

FIG. 50 is a cross-sectional view of the visual display device 1 of Example 13 taken along the rotationally symmetrical axis 2 of the ocular optical system 5, FIG. 51 is a plan view of FIG. 50, and FIG. 52 is a diagram showing lateral aberration of the entire optical system.

In the visual display device of Example 13 including an image display element 3 having a curved surface and the ocular optical system 5 that allows a viewer to observe an image displayed on the image display element 3 as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The image display element 3 has a Y-toric surface.

The ocular optical system 5 includes the transmission optical element 5b whose both surfaces are Y-toric surfaces and the reflection optical element 5a having a vertically asymmetric extended rotation free-form surface with positive power.

In the reverse raytrace, light flux emitted from the entrance pupil E is passed through the transmission optical element 5b of the ocular optical system 5, reflected by the reflection optical element 5a, and imaged on the image display element 3.

The specifications of Example 13 are as follows.

| Viewing angle (aberration representation): | 50.00° vertically |
|---|---|
| Entrance pupil diameter (reverse raytrace): | 4.00 |

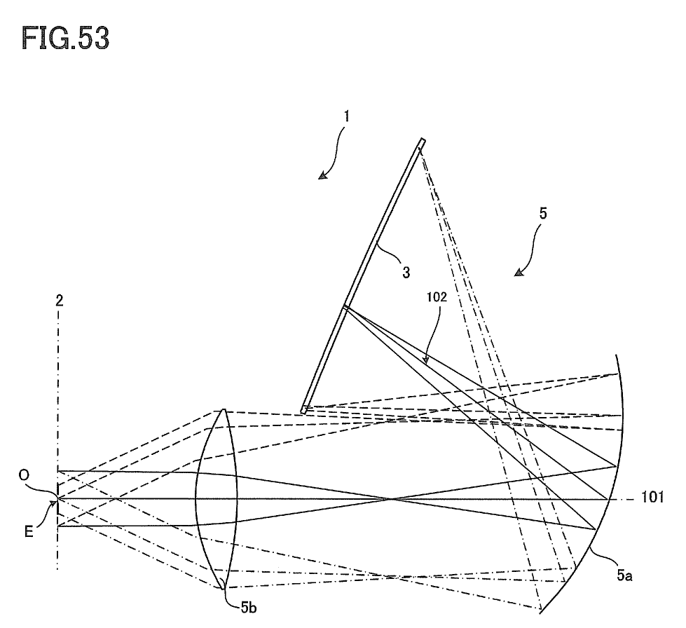

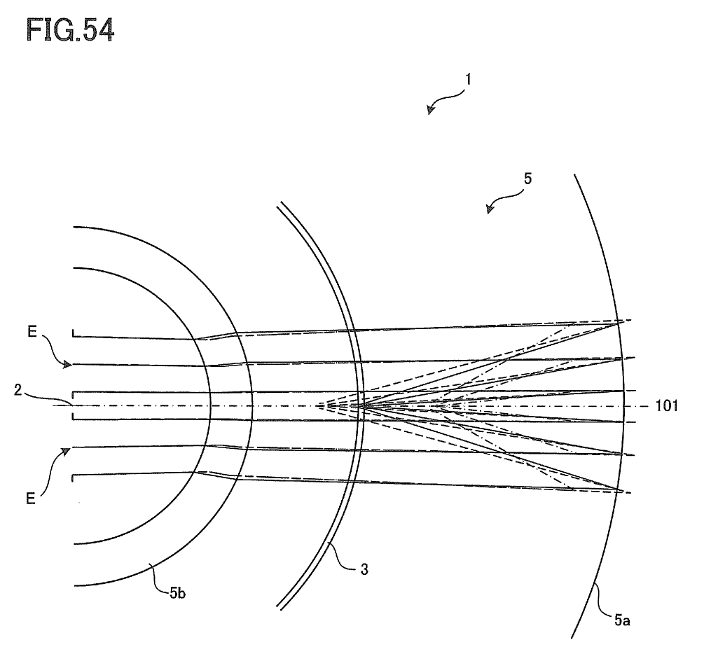

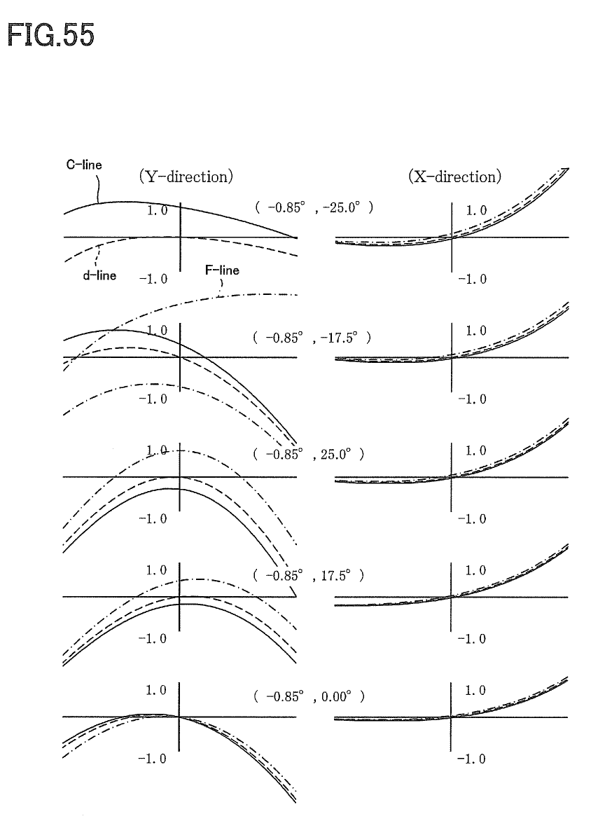

FIG. 53 is a cross-sectional view of the visual display device 1 of Example 14 taken along the rotationally symmetrical axis 2 of the ocular optical system 5, FIG. 54 is a plan view of FIG. 53, and FIG. 55 is a diagram showing lateral aberration of the entire optical system.

In the visual display device of Example 14 including an image display element 3 having a curved surface and the ocular optical system 5 that allows a viewer to observe an image displayed on the image display element 3 as a virtual image in a remote location, the ocular optical system 5 has at least one reflection optical element 5a, at least one transmission optical element 5b, and a visual axis 101 including a central main light beam in the reverse raytrace of the ocular optical system 5 which is directed from the center of an entrance pupil E toward the reflection optical element 5a through the transmission optical element 5b. The number of times of image formation is different between in a first cross-section including the visual axis 101 and in a second cross-section which is perpendicular to the first cross-section and includes the visual axis 101.

The image display element 3 has a Y-toric surface.

The ocular optical system 5 includes the transmission optical element 5b whose both surfaces are Y-toric surfaces and the reflection optical element 5a having a vertically asymmetric extended rotation free-form surface with positive power.

In the reverse raytrace, light flux emitted from the entrance pupil E is passed through the transmission optical element 5b of the ocular optical system 5, reflected by the reflection optical element 5a, and imaged on the image display element 3.

The specifications of Example 14 are as follows.

| Viewing angle (aberration representation): | 50.00° vertically |
|---|---|
| Entrance pupil diameter (reverse raytrace): | 4.00 |

The constructional parameters in Examples 8 to 14 are shown below, wherein the acronym “ERFS” indicates an extended rotation free-form surface.

### Example 8

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ | 0.00 | Eccentricity (1) | | |
| | (Entrance | | | | |
| | pupil) | | | | |
| 2 | ERFS (1) | 0.00 | | 1.5163 | 64.1 |
| 3 | ERFS (2) | 0.00 | | 1077.0524 | −3.5 |
| | (DOE) | | | | |
| 4 | ERFS (3) | 0.00 | | | |
| 5 | ERFS (4) | 0.00 | | | |
| | (RE) | | | | |
| Image | ERFS (5) | | Eccentricity (2) | | |
| Surface | | | | | |

ERFS (1) (Y-toric surface)

| | |
|---|---|
| RY | 127.82 |
| θ | 0.00 |
| R | 100.00 |
| C1 | −2.2902E+000 |

ERFS (2) (Y-toric surface)

| | |
|---|---|
| RY | −163.00 |
| θ | 0.00 |
| R | 130.00 |
| C1 | −3.5586E+000 |

ERFS (3) (Y-toric surface)

| | |
|---|---|
| RY | −163.00 |
| θ | 0.00 |
| R | 130.00 |
| C1 | −3.5573E+000 |

ERFS (4) (Vertically asymmetric ERFS)

| | |
|---|---|
| RY | −205.41 |
| θ | −20.00 |
| R | 400.00 |
| C1 | 6.0934E−002 |
| C4 | −1.0671E−006 |

ERFS (5) (Conical surface)

| | |
|---|---|
| RY | 0.00 |
| θ | −26.28 |
| R | 213.01 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 157.17 | Z | 0.00 |
| α | −26.28 | β | 0.00 | γ | 0.00 |

### Example 9

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ | 0.00 | Eccentricity (1) | | |
| | (Entrance | | | | |
| | pupil) | | | | |
| 2 | ERFS (1) | 0.00 | | 1.5163 | 64.1 |
| 3 | ERFS (2) | 0.00 | | | |
| 4 | ERFS (3) | 0.00 | | 1.5163 | 64.1 |
| 5 | Fresnel (1) | 0.00 | Eccentricity (2) | 1.5163 | 64.1 |
| | (RE) | | | | |
| 6 | ERFS (3) | 0.00 | | | |
| Image | ERFS (4) | 0.00 | Eccentricity (3) | | |
| Surface | | | | | |

Fresnel (1)

| | |
|---|---|
| RY | −300.00 |
| RX | −395.00 |
| SLOPE | 3.25E−001 |

The angle of inclination of the Fresnel board (A tangent for the Y-axis) is
−19.00°.

ERFS (1) (Y-toric surface)

| | |
|---|---|
| RY | 99.19 |
| θ | 0.00 |
| R | 100.00 |
| C1 | −1.5949E+000 |

ERFS (2) (Y-toric surface)

| | |
|---|---|
| RY | −110.85 |
| θ | 0.00 |
| R | 130.00 |
| C1 | −5.0616E+000 |

ERFS (3) (Conical surface)

| | |
|---|---|
| RY | ∞ |
| θ | −19.00 |
| R | 395.00 |

ERFS (4) (Conical surface)

| | |
|---|---|
| RY | ∞ |
| θ | −24.33 |
| R | 210.14 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 0.00 | Z | 400.00 |
| α | 0.00 | β | 0.00 | γ | 0.00 |

Eccentricity (3)

| | | | | | |
|---|---|---|---|---|---|
| X | 0.00 | Y | 148.55 | Z | 0.00 |
| α | 0.00 | β | 0.00 | γ | 0.00 |

### Example 10

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ | 0.00 | Eccentricity (1) | | |
| | (Entrance | | | | |
| | pupil) | | | | |
| 2 | Fresnel (1) | 0.00 | Eccentricity (2) | 1.5163 | 64.1 |
| 3 | ERFS (2) | 0.00 | | | |
| 4 | ERFS (3) | 0.00 | | | |
| | (RE) | | | | |
| Image | ERFS (4) | | Eccentricity (3) | | |
| Surface | | | | | |

Fresnel (1)

| | |
|---|---|
| RY | 50.00 |
| RX | −100.00 |
| k | −1.00 |

ERFS (2) (Sylindrical surface)

| | |
|---|---|
| RY | ∞ |
| θ | 0.00 |
| R | 101.00 |

ERFS (3) (Vertically asymmetric ERFS)

| | |
|---|---|
| RY | −232.69 |
| θ | −19.00 |
| R | 400.00 |
| C1 | −2.4723E−001 |
| C4 | −1.0549E−006 |

ERFS (4) (Conical surface)

| | |
|---|---|
| RY | 0.00 |
| θ | −38.09 |
| R | 218.13 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 0.00 | Z | 100.00 |
| α | 0.00 | β | 0.00 | γ | 0.00 |

Eccentricity (3)

| | | | | | |
|---|---|---|---|---|---|
| X | 0.00 | Y | 142.60 | Z | 0.00 |
| α | 0.00 | β | 0.00 | γ | 0.00 |

### Example 11

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ | 0.00 | Eccentricity (1) | | |
| | (Entrance | | | | |
| | pupil) | | | | |
| 2 | Fresnel (1) | 0.00 | Eccentricity (2) | 1.5163 | 64.1 |
| 3 | ERFS (1) | 0.00 | | | |
| 4 | ERFS (2) | 0.00 | | 1.5163 | 64.1 |
| 5 | Fresnel (2) | 0.00 | Eccentricity (3) | 1.5163 | 64.1 |
| | (RE) | | | | |
| 6 | ERFS (2) | 0.00 | | | |
| Image | ERFS (3) | | Eccentricity (4) | | |
| Surface | | | | | |

Fresnel (1)

| | |
|---|---|
| RY | 49.70 |
| RX | −120.00 |
| k | −1.1618E+000 |

Fresnel (2)

| | |
|---|---|
| RY | −276.82 |
| RX | −400.00 |
| k | −4.0447E+000 |

ERFS (1) (Sylindrical surface)

| | |
|---|---|
| RY | 0.00 |
| θ | 0.00 |
| R | 121.00 |

ERFS (2) (Sylindrical surface)

| | |
|---|---|
| RY | 0.00 |
| θ | 0.00 |
| R | 395.00 |

ERFS (3) (Conical surface)

| | |
|---|---|
| RY | 0.00 |
| θ | −28.84 |
| R | 213.60 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 0.00 | Z | 120.00 |
| α | 0.00 | β | 0.00 | γ | 0.00 |

Eccentricity (3)

| | | | | | |
|---|---|---|---|---|---|
| X | 0.00 | Y | 42.05 | Z | 400.00 |
| α | 0.00 | β | 0.00 | γ | 0.00 |

Eccentricity (3)

| | | | | | |
|---|---|---|---|---|---|
| X | 0.00 | Y | 77.33 | Z | 0.00 |
| α | 0.00 | β | 0.00 | γ | 0.00 |

### Example 12

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ | 0.00 | Eccentricity (1) | | |
| | (Entrance | | | | |
| | pupil) | | | | |
| 2 | ERFS (1) | 0.00 | | 1.5163 | 64.1 |
| 3 | ERFS (2) | 0.00 | | | |
| 4 | ERFS (3) | 0.00 | | | |
| | (RE) | | | | |
| Image | ERFS (4) | | Eccentricity (2) | | |
| Surface | | | | | |

ERFS (1) (Y-toric surface)

| | |
|---|---|
| RY | 120.00 |
| θ | 0.00 |
| R | 100.00 |
| C1 | −2.0000E+000 |

ERFS (2) (Y-toric surface)

| | |
|---|---|
| RY | −120.00 |
| θ | 0.00 |
| R | 130.00 |
| C1 | −2.0000E+000 |

ERFS (3) (Vertically asymmetric ERFS)

| | |
|---|---|
| RY | −200.00 |
| θ | −16.00 |
| R | 400.00 |
| C1 | −7.0000E−001 |
| C4 | −1.0000E−006 |

ERFS (4) (Y-toric surface)

| | |
|---|---|
| RY | −400.00 |
| θ | −25.00 |
| R | 214.92 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 120.00 | Z | 0.00 |
| α | 0.00 | β | 0.00 | γ | 0.00 |

### Example 13

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ | 0.00 | Eccentricity (1) | | |
| | (Entrance | | | | |
| | pupil) | | | | |
| 2 | ERFS (1) | 0.00 | | 1.5163 | 64.1 |
| 3 | ERFS (2) | 0.00 | | | |
| 4 | ERFS (3) | 0.00 | | | |
| Image | ERFS (4) | | Eccentricity (2) | | |
| Surface | | | | | |

ERFS (1) (Y-toric surface)

| | |
|---|---|
| RY | 100.00 |
| θ | 0.00 |
| R | 100.00 |
| C1 | −3.6991E+000 |

ERFS (2) (Y-toric surface)

| | |
|---|---|
| RY | −100.00 |
| θ | 0.00 |
| R | 130.00 |
| C1 | −5.9467E−001 |

ERFS (3) (Vertically asymmetric ERFS)

| | |
|---|---|
| RY | −219.36 |
| θ | −16.00 |
| R | 100.00 |
| C1 | −4.3365E+000 |
| C4 | −2.0797E−006 |

ERFS (4) (Y-toric surface)

| | |
|---|---|
| RY | −508.63 |
| θ | −19.29 |
| R | 202.71 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 123.41 | Z | 0.00 |
| α | 0.00 | β | 0.00 | γ | 0.00 |

### Example 14

| Surface | Radius | | | Refractive | Abbe |
|---|---|---|---|---|---|
| number | of curvature | Plane gap | Eccentricity | index | number |
| Object | ∞ | −2000.00 | | | |
| 1 | ∞ | 0.00 | Eccentricity (1) | | |
| | (Entrance | | | | |
| | pupil) | | | | |
| 2 | ERFS (1) | 0.00 | | 1.5163 | 64.1 |
| 3 | ERFS (2) | 0.00 | | | |
| 4 | ERFS (3) | 0.00 | | | |
| Image | ERFS (4) | | Eccentricity (2) | | |
| Surface | | | | | |

ERFS (1) (Y-toric surface)

| | |
|---|---|
| RY | 104.47 |
| θ | 0.00 |
| R | 100.00 |
| C1 | −1.5027E+000 |

ERFS (2) (Y-toric surface)

| | |
|---|---|
| RY | −228.04 |
| θ | 0.00 |
| R | 130.00 |
| C1 | −3.5586E+000 |

ERFS (3) (Vertically asymmetric ERFS)

| | |
|---|---|
| RY | −200.53 |
| θ | 0.00 |
| R | 400.00 |
| C1 | −8.2605E−002 |
| C4 | −1.1141E−006 |

ERFS (4) (Y-toric surface)

| | |
|---|---|
| RY | ∞ |
| θ | −23.28 |
| R | 207.49 |

Eccentricity (1)

| | | | | | |
|---|---|---|---|---|---|
| X | 30.00 | Y | 0.00 | Z | 0.00 |
| α | 0.00 | β | 0.00 | γ | 0.00 |

Eccentricity (2)

| | | | | | |
|---|---|---|---|---|---|
| X | 0.00 | Y | 140.06 | Z | 0.00 |
| α | 0.00 | β | 0.00 | γ | 0.00 |

The light beam is traced with the width between both eyes of a viewer set to X30 mm in eccentricity (1) (i.e., 60 mm width in the light path).

Further, as the ray tracing method, reverse raytrace from the eyeballs of a viewer toward the image display element 3 is performed.

Values of various pieces of data in the respective Examples are shown below.

| Various | | | | |
|---|---|---|---|---|
| data | Example 8 | Example 9 | Example 10 | Example 11 |
| Ry | −205.4 | −300.0 | −232.7 | −276.8 |
| Rx | 400.0 | 400.0 | 400.0 | 400.0 |
| Fy | 140.0 | 106.6 | 101.7 | 101.1 |

| Various data | Example 12 | Example 13 | Example 14 |
|---|---|---|---|
| Ry | −200.0 | −219.4 | −200.5 |
| Rx | −400.0 | −400.0 | −400.0 |
| Fy | 121.4 | 102.1 | 143.2 |

Next, a third embodiment of the present invention will be described. In the third embodiment, transmission optical elements 5b and 5c are disposed between the reflection optical element 5a of the ocular optical system 5 of the first or second embodiment and a pupil E of a viewer.

The transmission optical elements 5b and 5c are at least a first transmission optical element 5b and a second transmission optical element 5c.

The optical system of the third embodiment has a feature in that the reflection optical element 5a has a comparatively small aberration and therefore a viewer can observe an image with a wide viewing angle. Whereas, aberration generated in the transmission optical element disposed between the reflection optical element 5a and the eyeballs of a viewer and having strong positive power only in one direction poses a comparative problem. Thus, in the third embodiment, two transmission optical elements are used so as to make the aberration less likely to occur.

Further, the at least two transmission optical elements 5b and 5c each have a rotationally symmetric surface with the same rotationally symmetrical axis as that of the reflection surface 5a.

By making the rotationally symmetric axes coincide in the vertical direction with respect to a viewer, it is possible to easily widen the horizontal viewing angle by extending the rotationally symmetric reflection optical element 5a in the rotation direction. Further, all the optical elements are rotationally symmetric, so that assembly of the optical elements becomes easy.

Further, the at least two transmission optical elements 5d are disposed symmetric with respect to the second cross-section.

By deviating the transmission optical elements 5d from the rotationally symmetrical axis of the reflection optical element in accordance with the positions of the left and right eyeballs, it is possible to eliminate eccentric aberration caused due to interpupillary distance, allowing a viewer to observe a high-definition observation image. In this case, the right eye observes in the left direction the light beam from the transmission optical element 5dL disposed for the left eye and, similarly, the left eye observes in the right direction the light beam from the transmission optical element 5dR disposed for the right eye, so that it is desirable to set a light shielding plate 51 between the adjacently disposed transmission optical elements 5dL and 5dR.

One of the transmission optical elements has the same rotationally symmetrical axis as that of the reflection surface 5a, and the other one thereof is disposed symmetric with respect to the second cross-section. A configuration in which the transmission optical element 5f whose rotationally symmetrical axis is deviated from that of the reflection optical element 5a bears positive power in the cross-section including the rotationally symmetrical axis while correcting image distortion and the transmission optical element 5e whose rotationally symmetrical axis is made to coincide with that of the reflection optical element 5a also bears positive power allows a viewer to observe a high-resolution observation image with less distortion.

In the visual display device of the third embodiment, the same configuration as that of the first or second embodiment may be applied to the part except the at least two transmission optical elements. For example, a configuration may be adopted in which only the image display element 3 having a cone-like curved surface is used, in place of the configuration in which the image display device 3, the projection optical system 4, and the diffusion plate 11 are used.

Examples 15 to 17 of the third embodiment will be described.

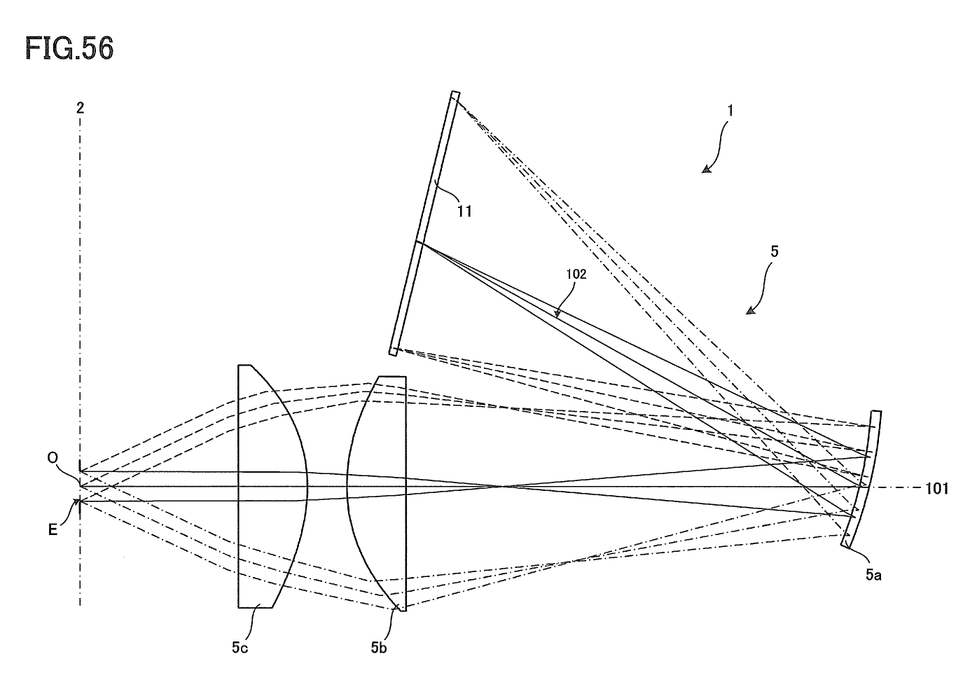

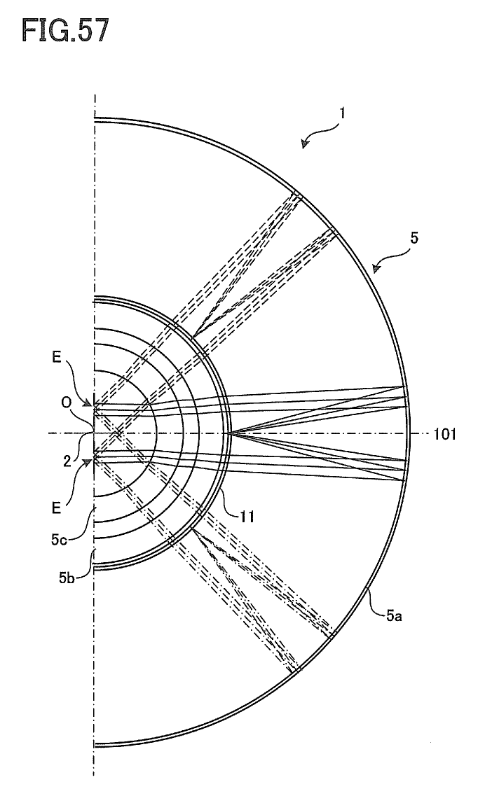

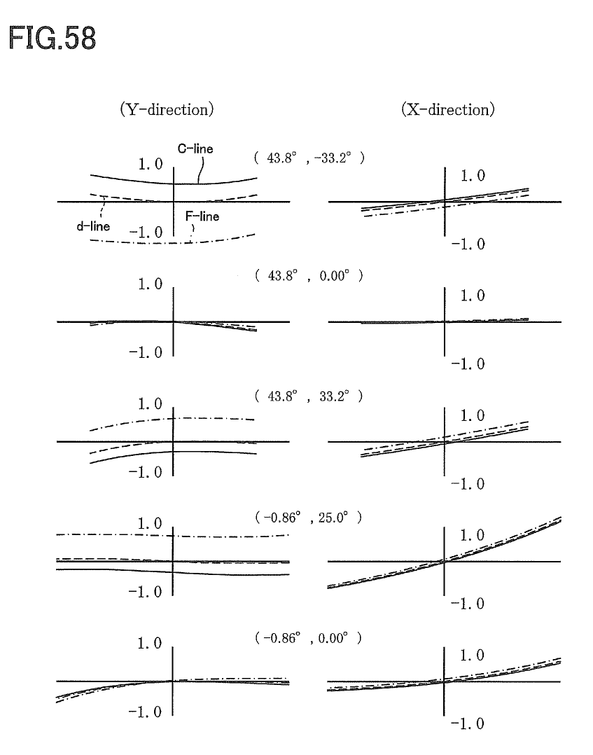

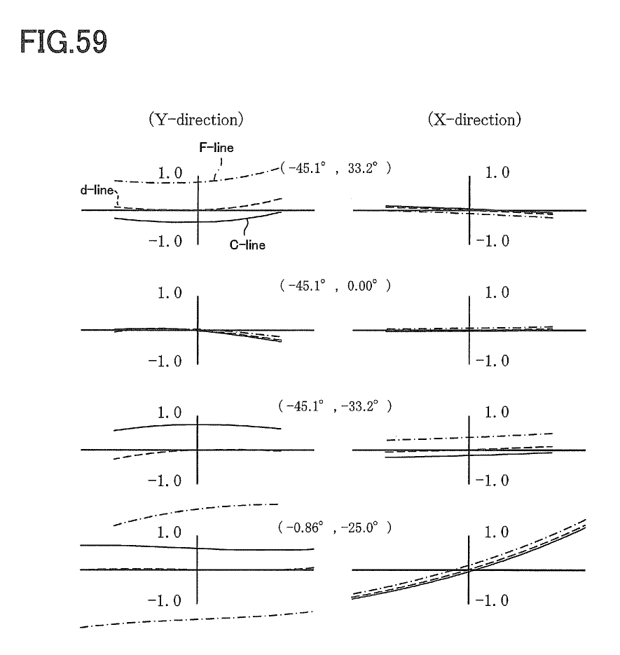

FIG. 56 is a cross-sectional view of the visual display device 1 of Example 15 taken along the rotationally symmetrical axis 2 of the ocular optical system 5, FIG. 57 is a plan view of FIG. 56, and FIGS. 58 and 59 are each a diagram showing lateral aberration of the entire optical system.

In the visual display device of Example 15 including a diffusion surface 11 disposed in the vicinity of an image projected by a not-shown projection optical system and the ocular optical system 5 that allows a viewer to observe the image projected by the not-shown projection optical system as a virtual image in a remote location, the ocular optical system 5 has at least one reflection optical element 5a, a first transmission optical element 5b having a rotationally symmetric surface with the same rotationally symmetrical axis as that of the reflection surface of the reflection optical element 5a, a second transmission optical element 5c disposed between the first transmission optical element 5b and an entrance pupil E and having a rotationally symmetric surface with the same rotationally symmetrical axis as that of the reflection surface of the reflection optical element 5a, and a visual axis 101 including a central main light beam in the reverse raytrace of the ocular optical system 5 which is directed from the center of an entrance pupil E toward the reflection optical element 5a through the first and second transmission optical elements 5b and 5c. The number of times of image formation is different between in a first cross-section including the visual axis 101 and in a second cross-section which is perpendicular to the first cross-section and includes the visual axis 101.

The ocular optical system 5 includes the first transmission optical element 5b whose both surfaces are extended rotation free-form surfaces, the second transmission optical element 5c whose both surfaces are extended rotation free-form surfaces, and the reflection optical element 5a whose transmission surface and reflection surface are extended rotation free-form surfaces.

The diffusion surface 11 has a conical surface and the image projected by the not-shown projection optical system is projected in the vicinity of the diffusion surface 11 in a cone shape.

In the reverse raytrace, light flux emitted from the entrance pupil E is passed through the second transmission optical element 5c and the first transmission optical element 5b of the ocular optical system 5 in series, reflected by the reflection optical element 5a, and intermediately imaged on the diffusion surface 11. The light flux emitted from the diffusion surface 11 enters the not-shown projection optical system and then reaches a predetermined position in a radial direction deviate from the optical axis of a not-shown image display element.

The specifications of Example 15 are as follows.

| Viewing angle (aberration representation): | 50.00° vertically |
|---|---|
| | 88° horizontally |
| Entrance pupil diameter (reverse raytrace): | 15.00 |

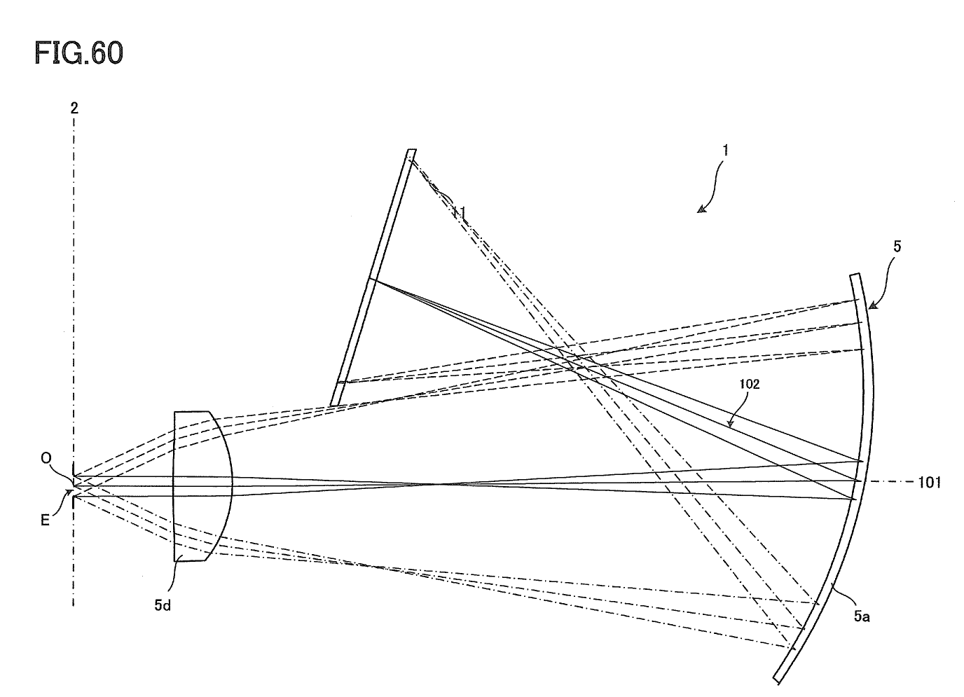

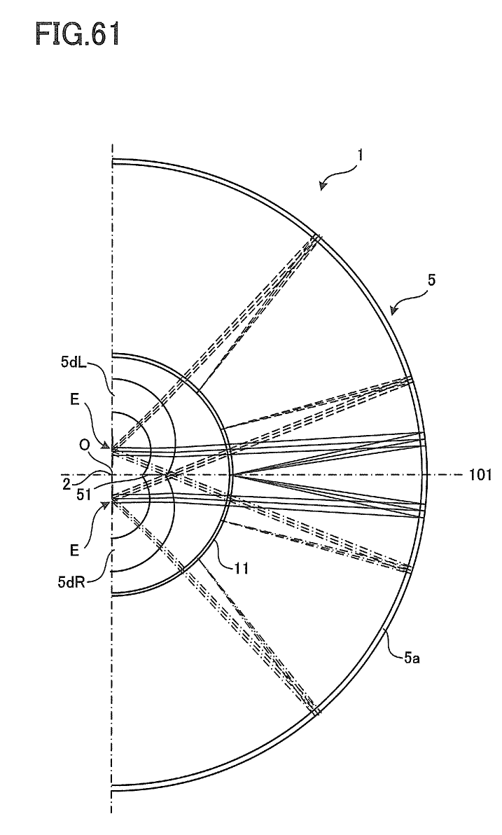

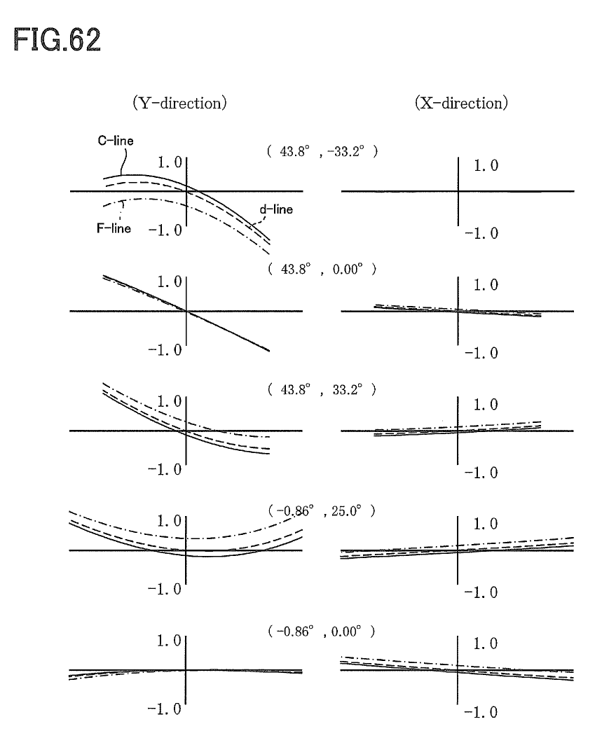

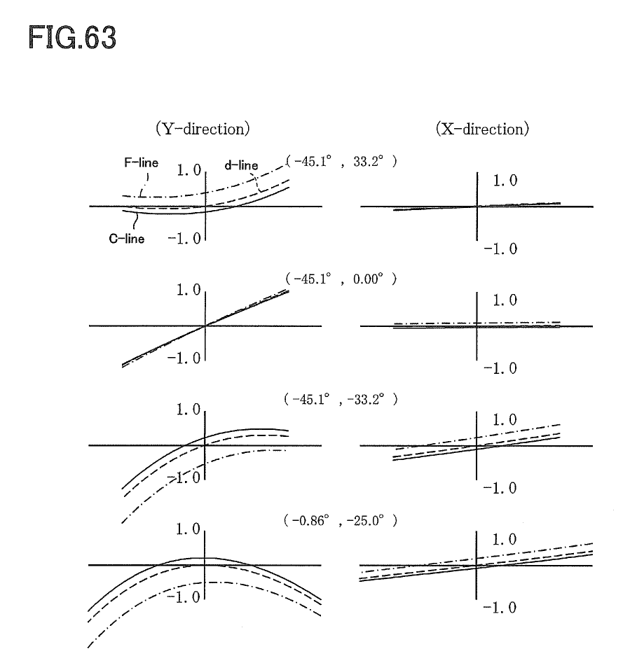

FIG. 60 is a cross-sectional view of the visual display device 1 of Example 16 taken along the rotationally symmetrical axis 2 of the ocular optical system 5, FIG. 61 is a plan view of FIG. 60, and FIGS. 62 and 63 are each a diagram showing lateral aberration of the entire optical system.

In the visual display device of Example 16 including a diffusion surface 11 disposed in the vicinity of an image projected by a not-shown projection optical system and the ocular optical system 5 that allows a viewer to observe the image projected by the not-shown projection optical system as a virtual image in a remote location, the ocular optical system 5 has at least one reflection optical element 5a, left and right transmission optical elements 5dL and 5dR corresponding to the left and right eyeballs of a viewer, a light shielding plate 51 disposed between the left and right transmission optical elements 5dL and 5dR, and a visual axis 101 including a central main light beam in the reverse raytrace of the ocular optical system 5 which is directed from the center of an entrance pupil E toward the reflection optical element 5a through the left transmission optical element 5dL or the right transmission optical element 5dR. The number of times of image formation is different between in a first cross-section including the visual axis 101 and in a second cross-section which is perpendicular to the first cross-section and includes the visual axis 101.

The ocular optical system 5 includes the left transmission optical element 5dL whose both surfaces are extended rotation free-form surfaces, the right transmission optical element 5dR whose both surfaces are extended rotation free-form surfaces, and the reflection optical element 5a whose transmission surface and reflection surface are extended rotation free-form surfaces.

The diffusion surface 11 has a conical surface and the image projected by the not-shown projection optical system is projected in the vicinity of the diffusion surface 11 in a cone shape.

In the reverse raytrace, light flux emitted from the entrance pupil E is passed through the left transmission optical element 5dL or the right transmission optical element 5dR of the ocular optical system 5, reflected by the reflection optical element 5a, and intermediately imaged on the diffusion surface 11. The light flux emitted from the diffusion surface 11 enters the not-shown projection optical system and then reaches a predetermined position in a radial direction deviate from the optical axis of a not-shown image display element.

The specifications of Example 16 are as follows.

| Viewing angle (aberration representation): | 50.00° vertically |
|---|---|
| | 88° horizontally |
| Entrance pupil diameter (reverse raytrace): | 10.00 |

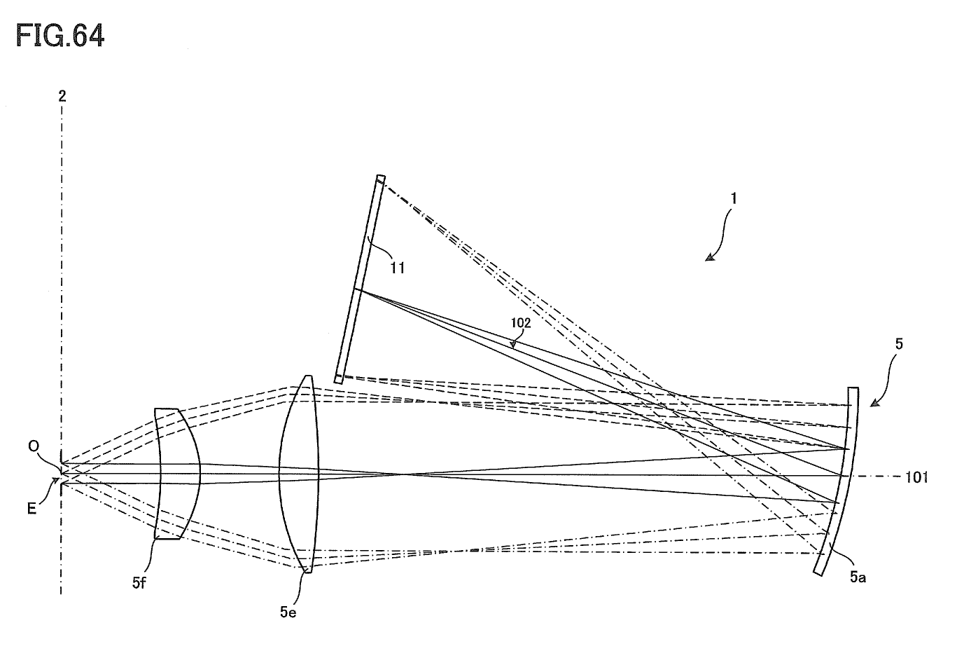

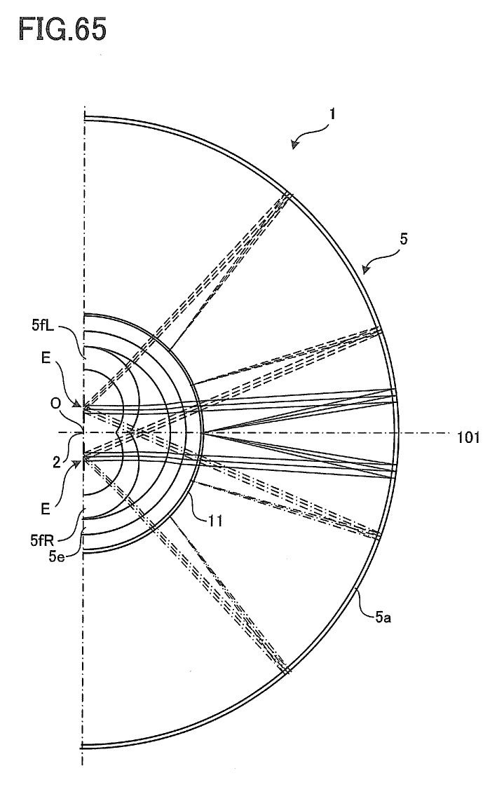

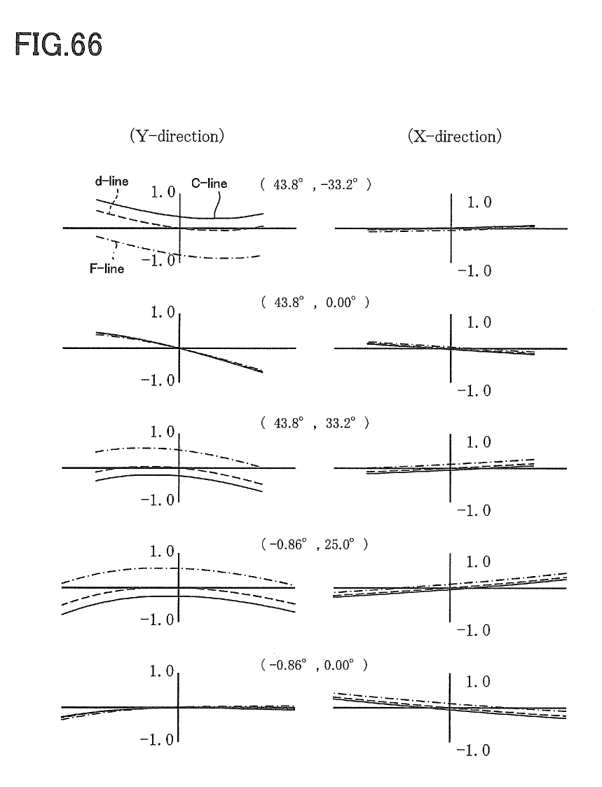

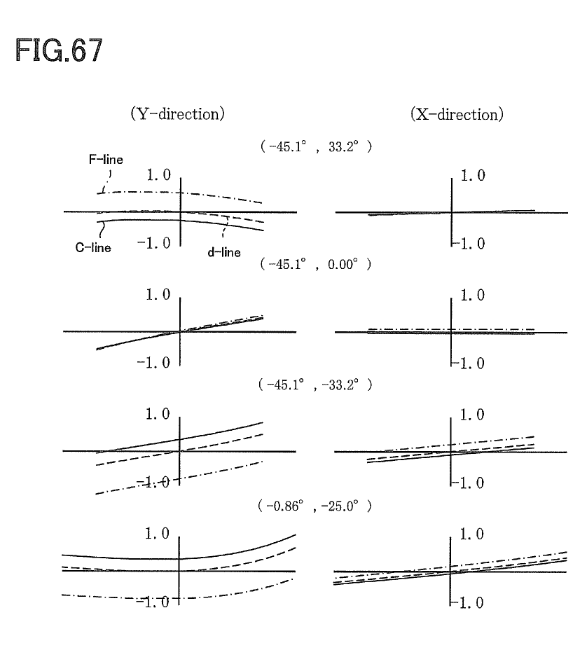

FIG. 64 is a cross-sectional view of the visual display device 1 of Example 17 taken along the rotationally symmetrical axis 2 of the ocular optical system 5, FIG. 65 is a plan view of FIG. 64, and FIGS. 66 and 67 are each a diagram showing lateral aberration of the entire optical system.

In the visual display device of Example 17 including a diffusion surface 11 disposed in the vicinity of an image projected by a not-shown projection optical system and the ocular optical system 5 that allows a viewer to observe the image projected by the not-shown projection optical system as a virtual image in a remote location, the ocular optical system 5 has at least one reflection optical element 5a, a first transmission optical element 5e having a rotationally symmetric surface with the same rotationally symmetrical axis as that of the reflection surface of the reflection optical element 5a, second left and right transmission optical elements 5fL and 5fR corresponding to the left and right eyeballs of a viewer, a light shielding plate 51 disposed between the second left and right transmission optical elements 5fL and 5fR, and a visual axis 101 including a central main light beam in the reverse raytrace of the ocular optical system 5 which is directed from the center of an entrance pupil E toward the reflection optical element 5a through the first and second transmission optical elements 5e and 5f. The number of times of image formation is different between in a first cross-section including the visual axis 101 and in a second cross-section which is perpendicular to the first cross-section and includes the visual axis 101.

The ocular optical system 5 includes the first transmission optical element 5e whose both surfaces are extended rotation free-form surfaces, the second left transmission optical element 5fL whose both surfaces are extended rotation free-form surfaces, the second right transmission optical element 5fR whose both surfaces are extended rotation free-form surfaces, and the reflection optical element 5a whose transmission surface and reflection surface are extended rotation free-form surfaces.

The diffusion surface 11 has a conical surface and the image projected by the not-shown projection optical system is projected in the vicinity of the diffusion surface 11 in a cone shape.

In the reverse raytrace, light flux emitted from the entrance pupil E is passed through the second left transmission optical element 5fL or the second right transmission optical element 5fR of the ocular optical system 5, further passed through the first transmission optical element 5e, reflected by the reflection optical element 5a, and intermediately imaged on the diffusion surface 11. The light flux emitted from the diffusion surface 11 enters the not-shown projection optical system and then reaches a predetermined position in a radial direction deviate from the optical axis of a not-shown image display element.

The specifications of Example 17 are as follows.

| Viewing angle (aberration representation): | 55.00° vertically |
|---|---|
| | 88° horizontally |
| Entrance pupil diameter (reverse raytrace): | 10.00 |

The constructional parameters in Examples 15 to 17 are shown below, wherein the acronym “ERFS” indicates an extended rotation free-form surface. The definitions of the coordinate system and eccentric surface are the same as those in the first and second embodiments.

The light beam is traced with the width between both eyes of a viewer set to X30 mm in eccentricity (1) (i.e., 60 mm width in the light path in the horizontal cross section).

Further, as the ray tracing method, reverse raytrace from the eyeballs of a viewer toward the image display element 3 is performed.

Although a horizontal viewing angle of up to 88° is covered in optical path diagram and aberration diagram, a viewer can observe an observation image with a viewing angle of 180° since the reflection surface is rotationally symmetric.

What is claimed is:

1. A visual display device comprising:
an image display element; and
an ocular optical system that allows a viewer to observe an image displayed on the image display element as a virtual image in a remote location,
the ocular optical system including:
at least one reflection optical element;
at least one transmission optical element; and
a visual axis including a central main light beam in the reverse raytrace of the ocular optical system which is directed from the center of an entrance pupil toward the reflection optical element through the transmission optical element, wherein
the number of times of image formation is different between in a first cross-section including the visual axis and in a second cross-section which is perpendicular to the first cross-section and includes the visual axis.

2. The visual display device according to claim 1, wherein
the number of times of image formation is 0 in the first cross-section and 1 in the second cross-section.

3. The visual display device according to claim 1, wherein
the reflection optical element and the transmission optical element each have a stronger refractive index in the direction toward the second cross-section.

4. The visual display device according to claim 1, wherein
the reflection optical element and the transmission optical element are each rotationally symmetric with respect to one rotationally symmetrical axis.

5. The visual display device according to claim 4, wherein
the second cross-section includes the rotationally symmetrical axis.

6. The visual display device according to claim 5, wherein
the reflection optical element is eccentric with respect to the visual axis in the second cross-section.

7. The visual display device according to claim 4, wherein
the visual axis and the rotationally symmetrical axis are perpendicular to each other.

8. The visual display device according to claim 1, wherein
the reflection optical element is a cylindrical linear Fresnel reflection element.

9. The visual display device according to claim 1, wherein
one side and the other side of the reflection optical element with respect to the visual axis have different shapes in the second cross-section.

10. The visual display device according to claim 1, wherein
the transmission optical element is a curved cylindrical linear Fresnel transmission element.

11. The visual display device according to claim 1, wherein
one side and the other side of the transmission optical element with respect to the visual axis have different shapes in the second cross-section.

12. The visual display device according to claim 1, wherein
the following conditional expression (1) is satisfied:

|Ry|<|Rx| (1)
where Rx is the radius of curvature of the reflection surface of the reflection optical element in the vicinity where the reflection optical element is intersected by the visual axis in the first cross-section, and Ry is the radius of curvature of the reflection surface of the reflection optical element in the vicinity where the reflection optical element is intersected by the visual axis in the second cross-section.

13. The visual display device according to claim 1, wherein
the following conditional expression (2) is satisfied:

|Fy|<|Rx| (2)
where Fy is the focal length of the cross-section including the rotationally symmetrical axis of the transmission optical element, and Rx is the radius of curvature of the reflection surface of the reflection optical element in the vicinity where the reflection optical element is intersected by the visual axis in the first cross-section.

14. The visual display device according to claim 1, comprising at least two transmission optical elements.

15. The visual display device according to claim 14, wherein
the at least two transmission optical elements each have a rotationally symmetric surface with the same rotationally symmetrical axis as that of the reflection surface.

16. The visual display device according to claim 14, wherein
the at least two transmission optical elements are disposed symmetric with respect to the second cross-section.

17. The visual display device according to claim 14, wherein
one of the transmission optical elements has the same rotationally symmetrical axis as that of the reflection surface, and the other one thereof is disposed symmetric with respect to the second cross-section.

18. The visual display device according to claim 4, further comprising:
a projection optical system that projects an image displayed on the image display element; and
a diffusion surface disposed in the vicinity of the image projected by the projection optical system, wherein
a projection image projected by the projection optical system is concentrically disposed with respect to the rotationally symmetrical axis.

19. The visual display device according to claim 18, wherein
the projection optical system is rotationally symmetric with respect to the rotationally symmetrical axis.

20. The visual display device according to claim 4, wherein
the image display element has a curved surface rotationally symmetric with respect to the rotationally symmetrical axis.
